(19) United States
(12) Patent Application Publication
(10) Pub. No.: US 2022/0390383 A1
(43) Pub. Date: Dec. 8, 2022

(54) IMAGING DEVICE, IMAGING SYSTEM, AND IMAGING METHOD

(71) Applicant: SONY SEMICONDUCTOR SOLUTIONS CORPORATION, KANAGAWA (JP)

(72) Inventor: SEIJIRO SAKANE, KANAGAWA (JP)

(21) Appl. No.: 17/641,954

(22) PCT Filed: Sep. 8, 2020
(86) PCT No.: PCT/JP2020/033937

§ 371 Date: Aug. 22, 2022

(30) Foreign Application Priority Data
Sep. 18, 2019 (JP) 2019-169086

(51) Int. Cl. G01N 21/88; G06T 5/50; G06T 7/00; G06T 7/90; G06V 10/143; G06V 10/28; G03B 11/00; G03B 15/02

(52) U.S. Cl. CPC G01N 21/88; G06T 5/50; G06T 7/0008; G06T 7/90; G06V 10/143; G06V 10/28; G03B 11/00; G03B 15/02; G06T 2207/10024; G06T 2207/10048; G06T 2207/10152; G06T 2207/20221; G06T 2207/30108

(57) ABSTRACT

Provided is an imaging device including: an imaging unit (130) that generates a one frame image by sequentially receiving each reflected light reflected by a subject by intermittently and sequentially irradiating the subject with each irradiation light having a different wavelength according to a position of the moving subject, temporarily and sequentially holding signal information based on the reflected light of each wavelength, and collectively reading the held signal information; and a combining unit (140) that generates a combined image by cutting a subject image corresponding to the reflected light of each wavelength from the one frame image and superimposing a plurality of the cut subject images.

### FIELD

The present disclosure relates to an imaging device, an imaging system, and an imaging method.

### BACKGROUND

In a production site or the like, an inspection device that inspects an appearance or the like of a product on the basis of a captured image when the product is shipped is used. For example, the inspection device can inspect whether the product is a non-defective product or a defective product on the basis of the captured image of the appearance of the product by a RGB camera. However, it may be difficult to accurately capture the appearance of the product from the captured image by the RGB camera that detects light having wavelengths in a wide range as three RGB primary colors. Therefore, in order to more accurately capture the appearance of the product, it has been proposed to use a spectral image obtained by finely dividing the wavelength of light related to a subject image into a plurality of wavelengths and detecting the wavelength. More specifically, by combining a plurality of spectral images obtained as described above into one image and using the combined image, it is intended to more accurately grasp the appearance of the product. For example, as examples of an imaging apparatus that acquires a spectral image, imaging apparatuses described in Patent Literatures 1 and 2 below can be mentioned.

### CITATION LIST

Patent Literature 1: JP 2015-41784 A Patent Literature
Patent Literature 2: JP 2015-126537 A

### SUMMARY

### Technical Problem

However, in the imaging apparatuses described in Patent Literatures 1 and 2, it is difficult to avoid a complicated configuration and furthermore, it is difficult to suppress an increase in processing time for obtaining one combined image.

Therefore, the present disclosure proposes an imaging device, an imaging system, and an imaging method capable of obtaining a combined image of spectral images with a simple configuration and at high speed.

### Solution to Problem

According to the present disclosure, an imaging device is provided. The imaging device includes: an imaging unit that generates a one frame image by sequentially receiving each reflected light reflected by a subject by intermittently and sequentially irradiating the subject with each irradiation light having a different wavelength according to a position of the moving subject, temporarily and sequentially holding signal information based on the reflected light of each wavelength, and collectively reading the held signal information; and a combining unit that generates a combined image by cutting a subject image corresponding to the reflected light of each wavelength from the one frame image and superimposing a plurality of the cut subject images.

Also, according to the present disclosure, an imaging system is provided. The imaging system includes: a moving device that moves a subject; an irradiation device that intermittently and sequentially irradiates the subject with irradiation light having a different wavelength according to a position of the moving subject; an imaging apparatus that generates a one frame image by sequentially receiving each reflected light reflected by the subject by the irradiation, temporarily and sequentially holding signal information based on the reflected light of each wavelength, and collectively reading the held signal information; and a combining device that generates a combined image by cutting a subject image corresponding to the reflected light of each wavelength from the one frame image and superimposing a plurality of the cut subject images.

Moreover, according to the present disclosure, an imaging method is provided. The imaging method includes: generating a one frame image by sequentially receiving each reflected light reflected by a subject by intermittently and sequentially irradiating the subject with each irradiation light having a different wavelength according to a position of the moving subject, temporarily and sequentially holding signal information based on the reflected light of each wavelength, and collectively reading the held signal information; and generating a combined image by cutting a subject image corresponding to the reflected light of each wavelength from the one frame image and superimposing a plurality of the cut subject images.

### BRIEF DESCRIPTION OF DRAWINGS

FIG. 1 is an explanatory diagram for explaining an example of a configuration of an imaging system 10 according to a first embodiment of the present disclosure.

FIG. 2 is a block diagram illustrating an example of a functional configuration of an imaging module 100 according to the same embodiment.

FIG. 3 is an explanatory diagram illustrating a planar configuration example of an imaging element 134 according to the same embodiment.

FIG. 4 is a flowchart for explaining an example of an imaging method according to the same embodiment.

FIG. 5 is an (first) explanatory diagram for explaining an example of the imaging method according to the same embodiment.

FIG. 6 is an (second) explanatory diagram for explaining an example of the imaging method according to the same embodiment.

FIG. 7 is an (third) explanatory diagram for explaining an example of the imaging method according to the same embodiment.

FIG. 8 is an (fourth) explanatory diagram for explaining an example of the imaging method according to the same embodiment.

FIG. 9 is a flowchart for explaining an example of an imaging method according to a second embodiment of the present disclosure.

FIG. 10 is an explanatory diagram for explaining an example of the imaging method according to the same embodiment.

FIG. 11 is a flowchart for explaining an example of an imaging method according to a third embodiment of the present disclosure.

FIG. 12 is an (first) explanatory diagram for explaining an example of the imaging method according to the same embodiment.

FIG. 13 is an (second) explanatory diagram for explaining an example of the imaging method according to the same embodiment.

FIG. 14 is an (third) explanatory diagram for explaining an example of the imaging method according to the same embodiment.

FIG. 15 is a flowchart for explaining an example of an imaging method according to a fourth embodiment of the present disclosure.

FIG. 16 is an explanatory diagram for explaining an example of the imaging method according to the same embodiment.

FIG. 17 is a flowchart for explaining an example of an imaging method according to a fifth embodiment of the present disclosure.

FIG. 18 is an explanatory diagram for explaining an example of the imaging method according to the same embodiment.

FIG. 19 is an explanatory diagram illustrating an example of an electronic apparatus 900 according to a sixth embodiment of the present disclosure.

FIG. 20 is a block diagram illustrating an example of a schematic configuration of a vehicle control system.

FIG. 21 is an explanatory diagram illustrating an example of installation positions of a vehicle exterior information detection unit and an imaging unit.

### DESCRIPTION OF EMBODIMENTS

Hereinafter, preferred embodiments of the present disclosure will be described in detail with reference to the accompanying drawings. Note that, in the present specification and the drawings, redundant description of components having substantially the same functional configuration is omitted by assigning the same reference numerals. Further, in the present specification and the drawings, similar components of different embodiments may be distinguished by adding different alphabets after the same reference numerals. However, when it is unnecessary to particularly distinguish each of the similar components, only the same reference numeral is assigned.

Note that the description will be given in the following order.

1. Background of embodiments of present disclosure created by present inventors

2. First Embodiment

2.1 Outline of imaging system

2.2 Detailed configuration of imaging module

2.3 Imaging method

2.4 First modification

2.5 Second modification

3. Second Embodiment

3.1 Detailed configuration of imaging module

3.2 Imaging method

4. Third Embodiment

4.1 Detailed configuration of imaging module

4.2 Imaging method

5. Fourth Embodiment

5.1 Detailed configuration of imaging module

5.2 Imaging method

6. Fifth Embodiment

6.1 Detailed configuration of imaging module

6.2 Imaging method

7. Sixth Embodiment

8. Application to mobile object

9. Summary

10. Supplement

An embodiment described below will be described as being applied to an inspection device that inspects, in a manufacturing line installed at a manufacturing site or the like, the presence or absence of scratches, the presence or absence of mixing of a foreign material, and whether or not an appearance of a manufactured product is an acceptable product suitable for shipment, on the basis of an image of the appearance of the product. However, the present embodiment is not limited to being applied to the inspection device, and may be applied to other devices or other purposes.

Further, the embodiment described below will be described as being applied to an imaging module operating in a global shutter system. Note that, in the following description, the global shutter system means a system for collectively reading imaging signals (signal information) obtained by respective imaging elements of the imaging module and generating a one frame image on the basis of the read imaging signals. However, the present embodiment is not limited to being applied to the imaging module of the global shutter system, and may be applied to imaging modules of other systems.

Furthermore, in the following description, since one frame means one reading, the one frame image is an image generated by performing collective reading of the imaging signals once.

### 1. Background of Embodiments of Present Disclosure Created by Present Inventors

As described above, in order to more accurately capture the appearance of the product, for example, it has been proposed to combine a plurality of spectral images, which are obtained by finely dividing a wavelength of light related to a subject image into a plurality of wavelengths and detecting the wavelength, into one image and use the combined image.

Specifically, as an example of a method for obtaining a spectral image, the imaging module uses optical components such as a diffraction grating and a mirror to disperse light in a vertical direction for one horizontal line and detect the light. In addition, the subject or the imaging module is moved (scanned) in a horizontal direction at a constant speed to disperse and detect the light as described above, thereby acquiring a two-dimensional image for each wavelength of the light.

Further, in Patent Literature 1 described above, strobe light having different wavelengths is continuously emitted to a subject, and reflected light from the spatially separated subject is incident on different positions on a light receiving surface on which a plurality of imaging elements of an imaging module are arranged, thereby detecting the light. However, in Patent Literature 1, as described above, a large number of optical components such as a diffraction grating and a mirror are required to spatially separate the reflected light, and it is difficult to avoid a complicated configuration and an increase in manufacturing cost of the imaging module.

Further, in Patent Literature 2 described above, an image for each wavelength is detected by switching the wavelength of light emitted from a light source for each frame. Specifically, in Patent Literature 2 described above, in a case where images of three different wavelengths are to be obtained, it takes an imaging time for three frames. Therefore, in Patent Literature 2 described above, it is difficult to suppress an increase in processing time for obtaining an image, and a real-time property is poor.

Accordingly, in view of such a situation, embodiments of the present disclosure that can obtain a combined image of spectral images with a simple configuration and at high speed have been created. Specifically, according to the embodiments of the present disclosure, a large number of optical components such as a diffraction grating and a mirror are not required, it is possible to avoid a complicated configuration and an increase in manufacturing cost of the imaging module and furthermore, it is possible to generate an image obtained by combining a plurality of spectral images into one image in an imaging time for one frame. Hereinafter, details of the embodiments of the present disclosure created by the present inventors will be sequentially described.

### 2. First Embodiment

<2.1 Outline of Imaging System>

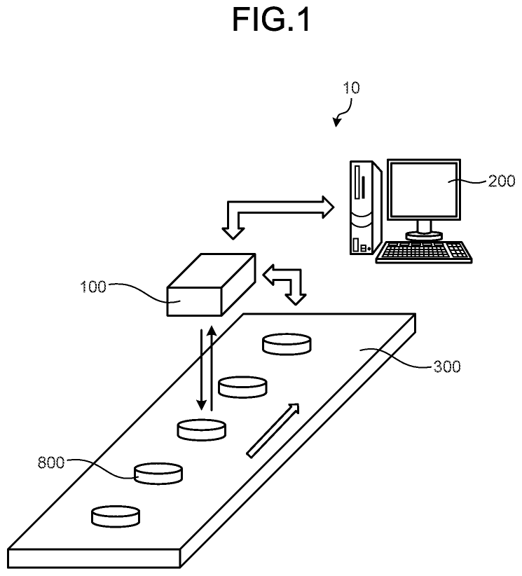

First, a configuration of an imaging system 10 according to an embodiment of the present disclosure will be described with reference to FIG. 1. FIG. 1 is an explanatory diagram for explaining an example of a configuration of the imaging system 10 according to the present embodiment. As illustrated in FIG. 1, the imaging system 10 according to the present embodiment can mainly include, for example, an imaging module 100, a control server 200, and a belt conveyor (moving device) 300. That is, the belt conveyor 300 is provided in a manufacturing line and conveys a manufactured product (in the following description, it is referred to as a subject 800). In addition, the imaging module 100 is applied to an inspection device that inspects the presence or absence of scratches, the presence or absence of mixing of a foreign material, and whether or not an appearance of the manufactured product is an acceptable product suitable for shipment, on the basis of an image of the appearance of the product. Hereinafter, an outline of each device included in the imaging system 10 will be sequentially described.

(Imaging Module 100)

The imaging module 100 irradiates the subject 800 with light, receives reflected light from the subject 800, generates a one frame image, and generates a combined image from the one frame image. A detailed configuration of the imaging module 100 will be described later.

(Control Server 200)

The control server 200 can control the imaging module 100 and furthermore, can monitor or control a traveling speed of the belt conveyor 300 described later, a position of the subject 800 on the belt conveyor 300, and the like. The control server 200 is realized by hardware such as a central processing unit (CPU), a read only memory (ROM), and a random access memory (RAM).

(Belt Conveyor 300)

The belt conveyor 300 is a moving device capable of moving the subject 800 under the control of the control server 200. Alternatively, the belt conveyor 300 is a moving device whose traveling speed is monitored by the control server 200 and which can move the subject 800. Note that, in the present embodiment, the moving device is not limited to the belt conveyor 300, and is not particularly limited as long as the moving device can move the subject 800.

Note that the devices in the imaging system 10 according to the present embodiment are communicably connected to each other via a network (not illustrated in the drawings). Specifically, for example, the imaging module 100, the control server 200, and the belt conveyor 300 can be connected to the network via a base station or the like (for example, a base station of a mobile phone, an access point of a wireless local area network (LAN), and the like) not illustrated in the drawings. Note that, as a communication system used in the network, any system can be applied regardless of wired or wireless (for example, WiFi (registered trademark), Bluetooth (registered trademark), and the like), but it is desirable to use a communication system capable of maintaining a stable operation.

<2.2 Detailed Configuration of Imaging Module>

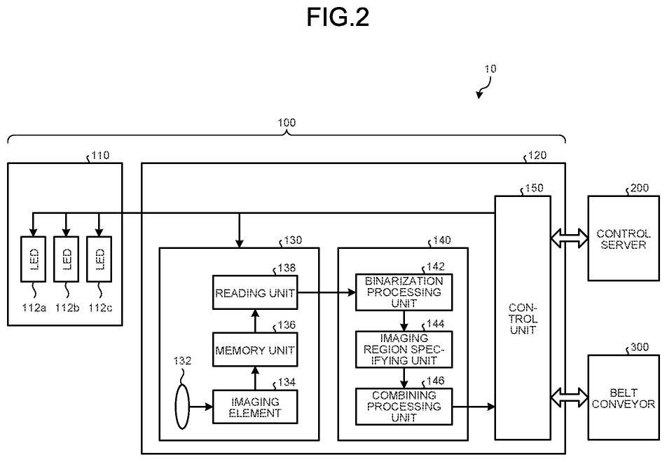

Next, a configuration of the imaging module 100 according to the present embodiment will be described with reference to FIG. 2. FIG. 2 is a block diagram illustrating an example of a functional configuration of the imaging module 100 according to the present embodiment. As illustrated in FIG. 2, the imaging module 100 according to the present embodiment can mainly include, for example, an irradiation unit 110 and an imaging device 120. Hereinafter, details of each block included in the imaging module 100 will be described. Note that, in the following description, the irradiation unit 110 and the imaging device 120 will be described as being configured as the integrated imaging module 100, but the present embodiment is not limited to being configured integrally as described above. That is, in the present embodiment, the irradiation unit 110 and the imaging device 120 may be configured separately.

(Irradiation Unit 110)

The irradiation unit 110 can intermittently and sequentially irradiate the subject 800 with irradiation light having different wavelengths (for example, wavelengths λ₁ to λ₇) according to positions of the moving subject 800 (pulse irradiation). Specifically, as illustrated in FIG. 2, the irradiation unit 110 has a plurality of light emitting elements (light emitting diodes; LEDs) 112 provided at different positions (specifically, provided at different positions along a traveling direction of the belt conveyor 300) and capable of emitting light having different wavelengths. In addition, in the present embodiment, the plurality of light emitting elements 112 sequentially emit the light of the corresponding wavelength by the corresponding light emitting element 112 according to the position of the subject 800, in other words, in synchronization with the subject 800 reaching the position where the light can be emitted by each light emitting element 112. For example, the plurality of light emitting elements 112 can include a plurality of LED light emitting diodes that emit near infrared light (having wavelengths of about 800 nm to 1700 nm). More specifically, in the example of FIG. 2, a light emitting element 112a can emit near infrared light having a wavelength of 900 nm, a light emitting element 112b can emit near infrared light having a wavelength of 1200 nm, and a light emitting element 112c can emit near infrared light having a wavelength of 1500 nm.

(Imaging Device 120)

As illustrated in FIG. 2, the imaging device 120 includes a single imaging apparatus, and can mainly have an imaging unit 130, a combining unit 140, and a control unit 150. Note that, in the example illustrated in FIG. 2, the imaging unit 130, the combining unit 140, and the control unit 150 are configured as an integrated device, but the present embodiment is not limited thereto, and these units may be separately provided. Hereinafter, details of each functional unit included in the imaging device 120 will be sequentially described.

—Imaging Unit 130—

The imaging unit 130 can sequentially receive the reflected light having the respective wavelengths (for example, the wavelengths λ₁ to λ₇) reflected by the moving subject 800. Further, the imaging unit 130 can generate a one frame image by temporarily and sequentially holding each imaging signal (signal information) based on the reception of the reflected light of each wavelength and then collectively reading the held imaging signals. Specifically, the imaging unit 130 has an optical system mechanism (not illustrated in the drawings) including a lens unit 132, a diaphragm mechanism (not illustrated in the drawings), a zoom lens (not illustrated in the drawings), a focus lens (not illustrated in the drawings), and the like. Furthermore, the imaging unit 130 has a plurality of imaging elements 134 that photoelectrically convert the light obtained by the optical system mechanism to generate imaging signals, a plurality of memory units 136 that temporarily hold the generated imaging signals, and a reading unit 138 that collectively reads the imaging signals from the plurality of memory units 136. Note that, although one imaging element 134 and one memory unit 136 are illustrated in FIG. 2, a plurality of imaging elements 134 and a plurality of memory units 136 can be provided in the imaging unit 130 according to the present embodiment.

More specifically, the optical system mechanism uses the above-described lens unit 132 or the like to condense the reflected light from the subject 800 on the plurality of imaging elements 134 as an optical image. For example, the imaging element 134 can be a compound sensor such as an InGaAs photodiode (InGaAs imaging element) capable of detecting near infrared light, or can be a silicon photodiode capable of detecting visible light. In addition, the plurality of imaging elements 134 are arranged in a matrix on a light receiving surface (surface on which an image is formed), and each imaging element 134 photoelectrically converts the formed optical image in units of pixels (units of imaging elements) to generate a signal of each pixel as an imaging signal. In addition, the plurality of imaging elements 134 output the generated imaging signals to the memory units 136 provided in units of pixels, for example. The memory units 136 can temporarily hold the output imaging signals. Furthermore, the reading unit 138 can output a one frame image to the combining unit 140 by collectively reading the imaging signals from the plurality of memory units 136. That is, in the present embodiment, the imaging unit 130 can operate in a global shutter system that collectively reads the imaging signals held in the respective memory units 136.

Further, in the present embodiment, for example, with the arrival of the subject 800 at the imaging position by the belt conveyor 300 as a trigger, the irradiation by the irradiation unit 110 described above and imaging of the global shutter system (multiple exposure) by the imaging unit 130 are performed in synchronization with each other.

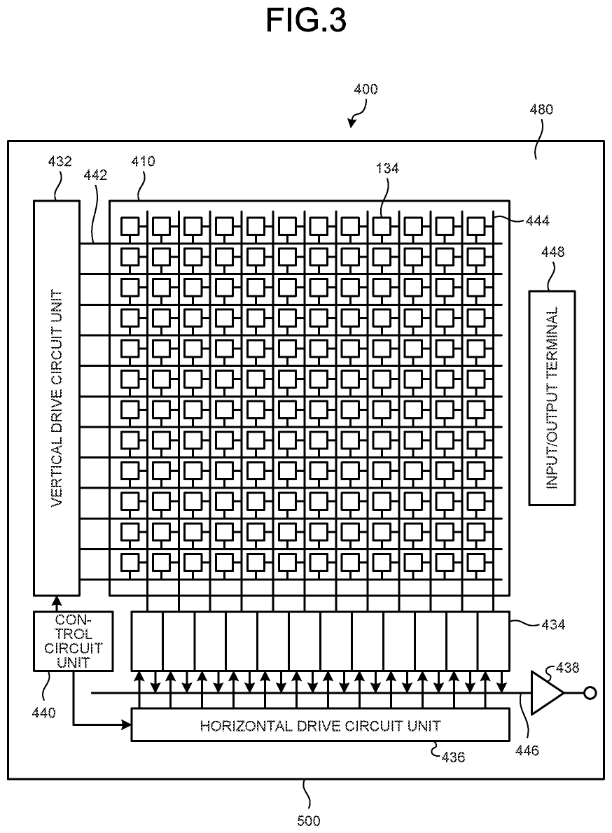

Furthermore, a planar configuration example of the plurality of imaging elements 134 described above will be described below with reference to FIG. 3. FIG. 3 is an explanatory diagram illustrating a planar configuration example of the imaging element 134 according to the present embodiment. As illustrated in FIG. 3, the plurality of imaging elements 134 according to the present embodiment are disposed in a matrix on a light receiving surface on a semiconductor substrate 500 made of, for example, silicon. Specifically, the imaging module 100 according to the present embodiment has a pixel array unit 410 in which the plurality of imaging elements 134 are disposed, and a peripheral circuit unit 480 provided so as to surround the pixel array unit 410. The peripheral circuit unit 480 includes a vertical drive circuit unit 432, a column signal processing circuit unit 434, a horizontal drive circuit unit 436, an output circuit unit 438, a control circuit unit 440, and the like. Hereinafter, details of the pixel array unit 410 and the peripheral circuit unit 480 will be described.

The pixel array unit 410 has a plurality of imaging elements (pixels) 134 two-dimensionally disposed in a matrix on the semiconductor substrate 500. Further, the plurality of pixels 134 may include normal pixels for generating pixel signals for image generation and a pair of phase difference detection pixels for generating pixel signals for focus detection. Each of the pixels 134 has a plurality of InGaAs imaging elements (photoelectric conversion elements) and a plurality of pixel transistors (for example, metal-oxide-semiconductor (MOS) transistors) (not illustrated in the drawings). More specifically, the pixel transistors can include a transfer transistor, a selection transistor, a reset transistor, and an amplification transistor, for example.

The vertical drive circuit unit 432 includes a shift register, for example, selects a pixel drive wire 442, supplies a pulse for driving the pixels 134 to the selected pixel drive wire 442, and drives the pixels 134 in units of rows. That is, the vertical drive circuit unit 432 selectively scans each of the pixels 134 of the pixel array unit 410 in a vertical direction (up-down direction in FIG. 3) sequentially in units of rows, and supplies a pixel signal based on the charges generated in accordance with the amount of light received by the photoelectric conversion element of each of the pixels 134 to the column signal processing circuit unit 434, which will be described later, through a vertical signal line 444.

The column signal processing circuit unit 434 is disposed for each column of the pixels 134, and performs signal processing such as noise removal for each pixel column on the pixel signals output from the pixels 134 for one row. For example, the column signal processing circuit unit 434 can perform signal processing such as correlated double sampling (CDS) and analog-digital (AD) conversion in order to remove pixel-specific fixed pattern noise.

The horizontal drive circuit unit 436 includes a shift register, for example, sequentially outputs horizontal scanning pulses to sequentially select each of the column signal processing circuit units 434 described above, and can output the pixel signal from each of the column signal processing circuit units 434 to a horizontal signal line 446.

The output circuit unit 438 can perform signal processing on the pixel signals sequentially supplied from each of the column signal processing circuit units 434 described above through the horizontal signal line 446, and can output the signals. The output circuit unit 438 may function as a functional unit that performs buffering, for example, or may perform processing such as black level adjustment, column variation correction, and various digital signal processing. Note that the buffering means temporarily storing the pixel signals in order to compensate for differences in processing speed and transfer speed in exchanging the pixel signals. Further, an input/output terminal 448 is a terminal for exchanging signals with an external device, and is not necessarily provided in the present embodiment.

The control circuit unit 440 can receive an input clock and data for giving an instruction on an operation mode or the like, and can output data such as internal information of the pixel 134. That is, the control circuit unit 440 generates a clock signal or a control signal to be a reference of the operation of the vertical drive circuit unit 432, the column signal processing circuit unit 434, the horizontal drive circuit unit 436, or the like, on the basis of a vertical synchronization signal, a horizontal synchronization signal, and a master clock. Then, the control circuit unit 440 outputs the generated clock signal or control signal to the vertical drive circuit unit 432, the column signal processing circuit unit 434, the horizontal drive circuit unit 436, or the like.

Note that the planar configuration example of the imaging element 134 according to the present embodiment is not limited to the example illustrated in FIG. 3, and may include, for example, another circuit unit or the like and is not particularly limited.

—Combining Unit 140—

The combining unit 140 cuts subject images corresponding to the reflected light of the respective wavelengths (for example, the wavelengths λ₁ to λ₇) from the one frame image output from the imaging unit 130, and superimposes a plurality of cut subject images to generate a combined image. The combining unit 140 is realized by, for example, hardware such as a CPU, a ROM, and a RAM. Specifically, as illustrated in FIG. 2, the combining unit 140 mainly has a binarization processing unit 142, an imaging region specifying unit 144, and a combining processing unit 146. Hereinafter, details of each functional unit included in the combining unit 140 will be sequentially described.

The binarization processing unit 142 can generate a two-step color tone image (for example, a black-and-white image) by performing binarization processing of converting the one frame image output from the imaging unit 130 into a two-step color tone. For example, the binarization processing unit 142 can generate a black-and-white image by comparing an imaging signal of each pixel unit (specifically, each pixel) in a one frame image with shading with a predetermined threshold, and converting a pixel unit having an imaging signal in one range into white and a pixel unit having an imaging signal in the other range into black, on the basis of the threshold. In the present embodiment, as described above, the binarization processing is performed on the one frame image with shading to convert the image into the black-and-white image. As a result, the contour of imaging of the subject 800 in the one frame image is clarified, and the subject image described later can be easily and accurately specified.

The imaging region specifying unit 144 specifies each subject image (for example, a region of interest (ROI)) corresponding to the reflected light of each of the wavelengths (for example, the wavelengths λ₁ to λ₇) in the one frame image. Specifically, for example, the imaging region specifying unit 144 can specify the center coordinates (for example, X and Y coordinates) of imaging of each subject 800 in the one frame image by detecting the contour of imaging of each subject 800 included in the two-step color tone image generated by the binarization processing unit 142. Further, the imaging region specifying unit 144 can specify the ROI, which is a region of imaging of the subject 800 corresponding to the reflected light of each wavelength, on the basis of the specified center coordinates. For example, the imaging region specifying unit 144 can specify each ROI in a one frame image by superimposing the center of a rectangular extraction frame having a preset size capable of including imaging of the subject 800 on the specified center coordinates. Note that, in the present embodiment, the extraction frame is not limited to a rectangular shape, and may have a polygonal shape, a circular shape, or a shape equal or similar to the shape of the subject 800 as long as the extraction frame has a size capable of including imaging of the subject 800. Furthermore, in the present embodiment, the specification of the ROI is not limited to being performed on the basis of the center coordinates, and may be performed, for example, on the basis of the detected contour of imaging of each subject 800 and is not particularly limited.

Further, in the present embodiment, the imaging region specifying unit 144 may specify each ROI by specifying an imaging position of an identification marker (not illustrated in the drawings) provided on the surface of the subject 800 in the one frame image without using the two-step color tone image. Furthermore, in the present embodiment, the imaging region specifying unit 144 may specify each ROI on the basis of a plurality of predetermined regions (for example, the coordinates of each vertex of the region are set in advance) designated in advance by the user in the one frame image without using the two-step color tone image.

Then, the combining processing unit 146 cuts each ROI from the one frame image on the basis of each ROI specified by the imaging region specifying unit 144 and superimposes a plurality of cut ROIs to generate a combined image. Specifically, the combining processing unit 146 performs position adjustment such that the center of imaging of the subject 800 included in each ROI and the contour are matched with each other, and superimposes the plurality of ROIs to generate a combined image. Note that, in the present embodiment, the combining processing unit 146 may generate a combined image by superimposing the plurality of ROIs in a state in which imaging of identification markers (not illustrated in the drawings) provided on the surface of the subject 800, included in the respective ROIs, are matched with each other, and the combining processing unit 146 is not particularly limited. Furthermore, when the combined image is generated, the combining processing unit 146 can generate pseudo color images with reference to color information (for example, red, green, and blue in a visible light band are assigned) assigned in advance to each of the wavelengths (for example, the wavelengths λ₁ to λ₇). In the present embodiment, a combined image of the pseudo color images is generated as described above, so that visibility of details in the image can be improved. Note that details of generation of the pseudo color image will be described later.

—Control unit 150—

The control unit 150 can control the imaging unit 130 such that the reflected light is received in synchronization with the irradiation of the irradiation unit 110. The control unit 150 is realized by hardware such as a CPU, a ROM, and a RAM, for example.

As described above, according to the imaging module 100 according to the present embodiment, a large number of optical components such as a diffraction grating and a mirror are not required, and it is possible to avoid a complicated configuration and an increase in manufacturing cost of the imaging module 100. That is, according to the present embodiment, the imaging module 100 having a simple configuration can be provided.

<2.3 Imaging Method>

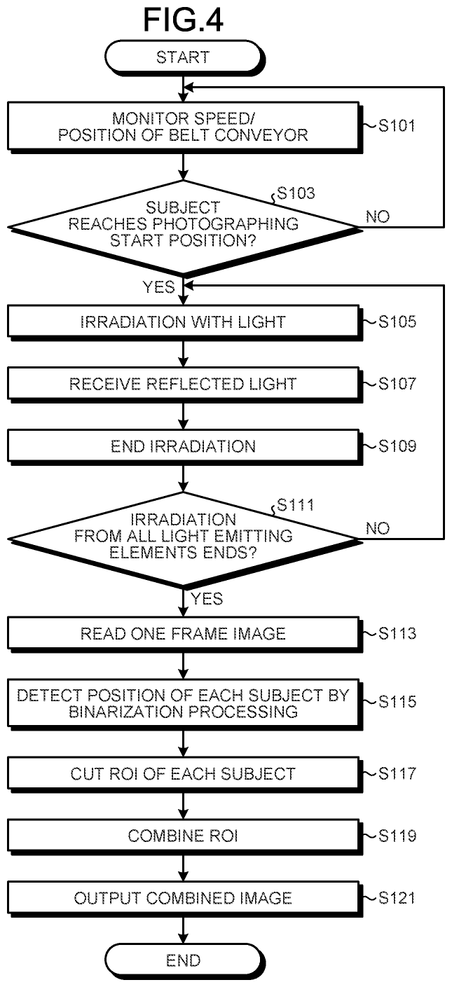

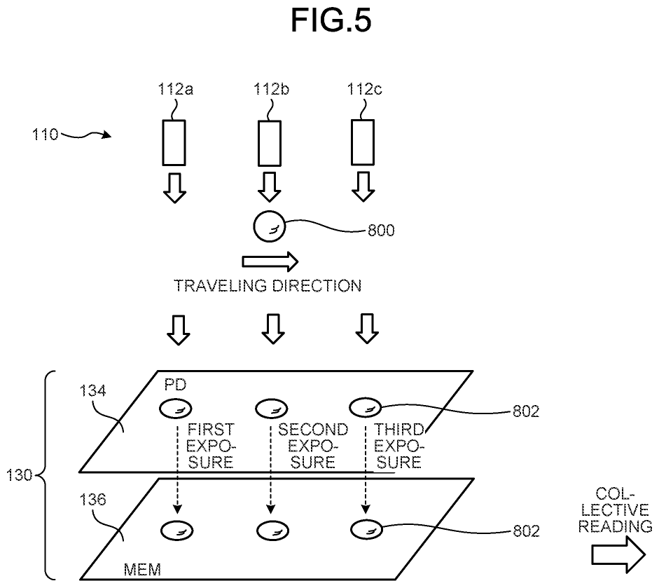

The imaging system 10 according to the present embodiment and the configurations of the devices included in the imaging system 10 have been described in detail above. Next, an imaging method according to the present embodiment will be described with reference to FIGS. 4 to 8. FIG. 4 is a flowchart for explaining an example of the imaging method according to the present embodiment. FIGS. 5 to 8 are explanatory diagrams for explaining an example of the imaging method according to the present embodiment. As illustrated in FIG. 4, the imaging method according to the present embodiment includes a plurality of steps including steps S101 to S121. Hereinafter, details of each step included in the imaging method according to the present embodiment will be described.

(Step S101)

For example, the control unit 150 monitors the traveling speed (for example, constant speed control) of the belt conveyor 300 or the position of the subject 800 on the belt conveyor 300 in cooperation with the control server 200.

(Step S103)

The control unit 150 determines whether or not the subject 800 reaches a photographing start position. In the present embodiment, when the subject 800 reaches the photographing start position, the process proceeds to a next step S105, and when the subject 800 does not reach the photographing start position, the process returns to the previous step S101. That is, in the present embodiment, as described above, the irradiation/light reception operation is performed in synchronization with the traveling of the belt conveyor 300. Note that the present embodiment is not limited to the process proceeding with the arrival of the subject 800 at the photographing start position as a trigger, and other events or the like may be used as a trigger. Further, in the present embodiment, the event serving as the trigger may be acquired from each device in the imaging system 10 or may be acquired from a device outside the imaging system 10, and the acquisition of the event is not particularly limited.

(Step S105)

The control unit 150 controls the light emitting element 112 corresponding to the position of the subject 800 and causes the light emitting element 112 to irradiate the subject 800 with light (for example, near infrared light having a predetermined wavelength) having a predetermined wavelength (for example, the wavelengths λ₁ to λ₇). Specifically, as illustrated in FIG. 5, each of the light emitting elements 112a to 112c irradiates the subject 800 with the light having the predetermined wavelength when the subject 800 reaches below the light emitting element.

(Step S107)

The control unit 150 controls the plurality of imaging elements 134 such that the plurality of imaging elements 134 receive the reflected light from the subject 800, in synchronization with the irradiation of the light emitting element 112 in step S105. For example, as illustrated in FIG. 5, the plurality of imaging elements 134 (photodiodes; PDs) receive light in synchronization with the irradiation of each of the light emitting elements 112a to 112c, generate imaging 802 of the subject obtained by the light reception as an imaging signal, and output the generated imaging signal to each memory unit 136 (memory: MEM). Furthermore, each memory unit 136 temporarily holds the imaging signal. Note that the imaging signal corresponds to the imaging 802 of the subject 800 corresponding to each of the wavelengths (for example, the wavelengths λ₁ to λ₇) of the light emitted by the light emitting element 112 in step S105, and each imaging 802 is included in a one frame image to be described later (that is, multiple exposure).

(Step S109)

The control unit 150 controls the corresponding light emitting element 112 and ends the irradiation.

(Step S111)

The control unit 150 determines whether or not all the light emitting elements 112 perform irradiation. In the present embodiment, when all the light emitting elements 112 perform the irradiation, the process proceeds to a next step S113, and when all the light emitting elements 112 do not perform the irradiation, the process returns to the previous step S105.

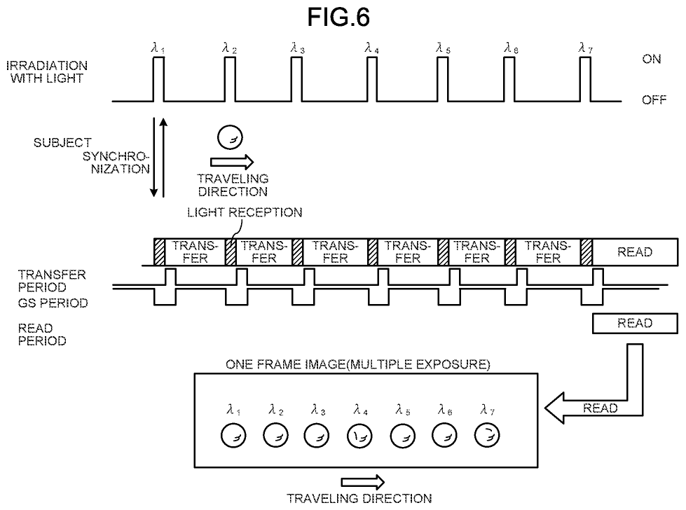

That is, in the present embodiment, as illustrated in the upper part of FIG. 6, the irradiation unit 110 sequentially irradiates the moving subject 800 with pulses of light having different wavelengths (for example, λ₁ to λ₇). Then, in the present embodiment, as illustrated in the middle part of FIG. 6, the reception of the reflected light from the subject 800 by the imaging element 134, the transfer of the imaging signal to the memory unit 136, and the temporary holding of the imaging signal by the memory unit 136 are sequentially executed in synchronization with irradiation timing. Next, as illustrated in the lower part of FIG. 6, in a subsequent step, by collectively reading the imaging signals from the respective memory units 136, in other words, by performing multiple exposure to capture the trajectory of the subject 800, it is possible to acquire a one frame image including the imaging 802 (spectral image) of the subject 800 corresponding to each wavelength.

(Step S113)

The control unit 150 controls the reading unit 138, collectively reads the imaging signals stored in each memory unit 136, acquires a one frame image including the imaging 802 (spectral image) of the subject 800 corresponding to each of the wavelengths (for example, the wavelengths λ₁ to λ₇), and outputs the acquired one frame image to the combining unit 140 (global shutter system).

(Step S115)

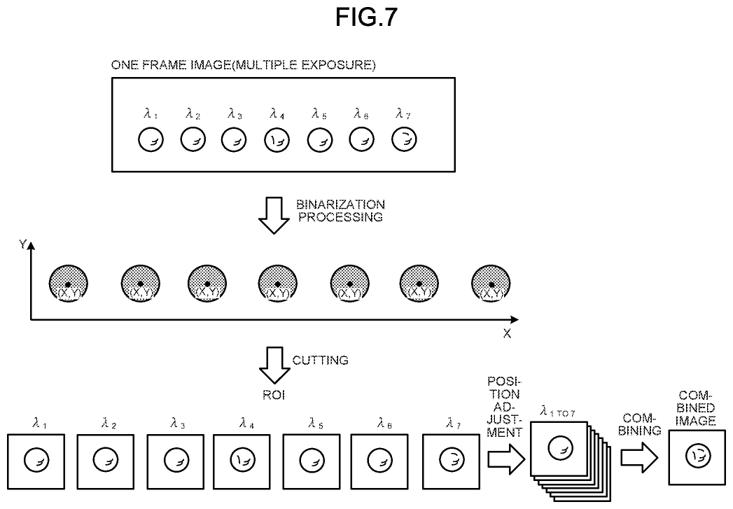

The control unit 150 controls the binarization processing unit 142 of the combining unit 140 and performs binarization processing of converting the one frame image acquired in step S113 into a two-step color tone to generate a two-step color tone image. For example, in step S115, a black-and-white image illustrated in the middle part of FIG. 7 can be obtained. Furthermore, the control unit 150 controls the imaging region specifying unit 144 of the combining unit 140, detects the contour or the like included in the image after the binarization processing, and detects the position of the imaging 802 of each subject 800. For example, in step S115, as illustrated in the middle part of FIG. 7, the center coordinates (X, Y) of the imaging 802 of each subject 800 are detected from the black-and-white image.

(Step S117)

As illustrated in the lower part of FIG. 7, the control unit 150 controls the combining processing unit 146 of the combining unit 140 and cuts each ROI having a predetermined extraction frame, on the basis of the position of each imaging 802 of the subject 800 detected in step S115.

(Step S119)

As illustrated in the lower part of FIG. 7, the control unit 150 controls the combining processing unit 146, performs position adjustment such that the center of the imaging of the subject 800 included in each ROI and the contour are matched with each other, and superimposes the plurality of cut ROIs. Furthermore, the control unit 150 controls the combining processing unit 146 and generates pseudo color images as a combined image with reference to color information assigned in advance to each of the wavelengths (for example, the wavelengths λ₁ to λ₇).

Hereinafter, an example of a method for generating the pseudo color image in the present embodiment will be described. Here, for easy understanding, a method for generating the pseudo color image will be described assuming that a one frame image including the imaging 802 (spectral image) of the subject 800 corresponding to the three wavelengths λ₁ to λ₃ is acquired.

In this example, it is assumed that, as the color information, red is assigned in advance to the wavelength λ₁, green is assigned in advance to the wavelength λ₂, and blue is assigned in advance to the wavelength λ₃. Furthermore, in the present embodiment, it is assumed that the plurality of imaging elements 134 of the imaging module 100 can detect visible light when the pseudo color image is generated. That is, it is assumed that, on a light receiving surface of the imaging module 100 where the plurality of imaging elements 134 are disposed in a matrix, an imaging element that detects red, an imaging element that detects green, and an imaging element that detects blue are arranged in a Bayer array.

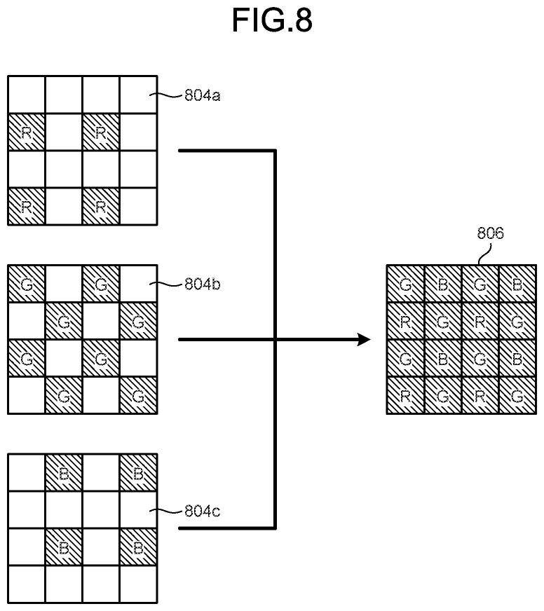

Then, in the present embodiment, under the above-described assignment and assumption conditions, the pseudo color images can be combined as follows. Specifically, first, as illustrated in the upper left part of FIG. 8, image data of the ROI corresponding to the wavelength λ₁ is assigned to the position of red (R) on the Bayer array, and a pixel data group 804a is generated. Next, as illustrated in the middle left part of FIG. 8, image data of the ROI corresponding to the wavelength λ₂ is assigned to the position of green (G) on the Bayer array, and a pixel data group 804b is generated. Further, as illustrated in the lower left part of FIG. 8, image data of the ROI corresponding to the wavelength λ₃ is assigned to the position of blue (B) on the Bayer array, and a pixel data group 804c is generated. Then, in the present embodiment, pseudo color images 806 illustrated on the right side of FIG. 8 can be combined by combining the pixel data groups 804a, 804b, and 804c in which the image data is assigned to the positions of the respective colors. In the present embodiment, the combined image of the pseudo color images 806 is generated as described above, so that visibility of details in the image can be improved.

Note that, in the present embodiment, the combining of the pseudo color images 806 is not limited to the above-described example, and may be performed using another method such as using an addition average for each pixel such as a color parameter.

(Step S121)

The control unit 150 controls the combining processing unit 146 and outputs the generated combined image to the control unit 150. Furthermore, the output combined image is converted into an appropriate format by the control unit 150 and is output to the control server 200 or the like, for example.

As described above, according to the present embodiment, since the combined image is generated using a one frame image, it is possible to generate an image obtained by combining a plurality of spectral images into one image in an imaging time for one frame. That is, according to the present embodiment, it is possible to obtain a combined image of spectral images at high speed.

<2.4 First Modification>

In the present embodiment, as a modification, as described above, each ROI can be specified on the basis of a plurality of predetermined regions designated in advance by the user in the one frame image without using the two-step color tone image.

<2.5 Second Modification>

Note that, in the above description, the combined image is generated by superimposing the plurality of cut ROIs, but the present embodiment and the first modification are not limited thereto. For example, in the present embodiment and the first modification, the one frame image may be output, or the ROIs cut from the one frame image may be output. For example, in this case, since images corresponding to the respective wavelengths of light can be separately acquired and analyzed, it is possible to easily recognize the presence or absence, distribution, and the like of components for the corresponding wavelengths.

### 3. Second Embodiment

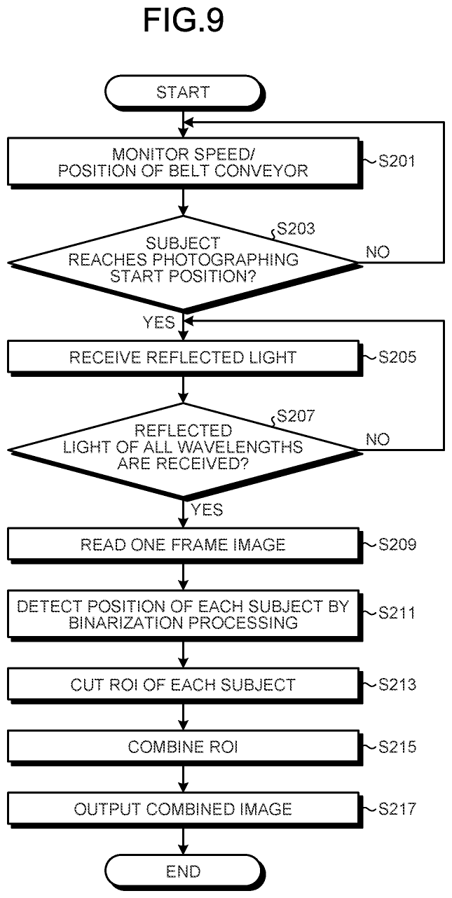

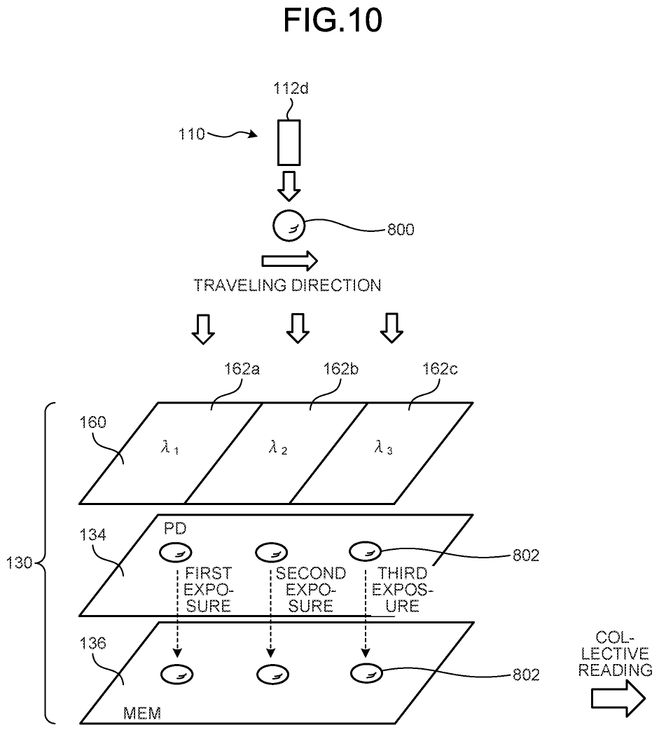

In the first embodiment described above, a plurality of light emitting elements 112 are provided in order to emit light having different wavelengths. However, by using a plurality of filters 162 (see FIG. 10), a combined image can be obtained similarly to the above-described embodiment even with one light emitting element 112d (see FIG. 10) that emits white light. In this way, in the present embodiment, the plurality of filters 162 are used, so that it is possible to avoid a complicated configuration of an irradiation unit 110 and an increase in manufacturing cost of the irradiation unit 110. Therefore, an embodiment in which a filter unit 160 (see FIG. 10) including the plurality of filters 162 is provided will be described as a second embodiment of the present disclosure with reference to FIGS. 9 and 10. FIG. 9 is a flowchart for explaining an example of an imaging method according to the present embodiment, and FIG. 10 is an explanatory diagram for explaining an example of the imaging method according to the present embodiment.

<3.1 Detailed Configuration of Imaging Module>

First, a detailed configuration of an imaging module 100 according to the second embodiment of the present disclosure will be described. In the following description, descriptions of points common to those of the above-described first embodiment will be omitted, and only different points will be described. In the present embodiment, the irradiation unit 110 of the imaging module 100 has the light emitting element 112d (see FIG. 10) capable of irradiating a subject 800 with white light. Note that the present embodiment is not limited to using the light emitting element 112d, and for example, an indoor light or the like may be used instead of the irradiation unit 110, or natural light may be used (in this case, the irradiation unit 110 becomes unnecessary.). That is, according to the present embodiment, the irradiation unit 110 having a special configuration is unnecessary, and a general lighting device or the like can be used.

Further, an imaging unit 130 of an imaging device 120 according to the present embodiment further has the filter unit 160 (see FIG. 10) on the side of the subject 800 of a lens unit 132. Specifically, as illustrated in FIG. 10, the filter unit 160 has a plurality of filters 162a, 162b, and 162c sequentially arranged along a traveling direction (moving direction) of a belt conveyor 300 (although the three filters 162a to 162c are illustrated in FIG. 10, the present embodiment is not limited to the three filters, and a plurality of filters can be provided). Each of the filters 162a, 162b, and 162c includes an on chip color filter (OCCF) of a narrowband or a plasmon filter (filter that transmits only a specific wavelength using surface plasmon), and can transmit light of a different wavelength. For example, the filters 162a, 162b, and 162c can transmit light having wavelengths λ₁ to λ₇ in the first embodiment.

Further, in the present embodiment, for example, with the arrival of the subject 800 at the imaging position by the belt conveyor 300 as a trigger, imaging of a global shutter system (multiple exposure) by the imaging unit 130 is performed.

As described above, in the present embodiment, since it is sufficient if there is one type of light emitting element 112d by using the plurality of filters 162, it is possible to avoid a complicated configuration of the irradiation unit 110 and an increase in manufacturing cost of the irradiation unit 110. Further, in the present embodiment, the irradiation unit 110 can be removed by using a general indoor light, natural light, or the like. That is, according to the present embodiment, the irradiation unit 110 having a special configuration is unnecessary, and a general lighting device or the like can be used.

<3.2 Imaging Method>

The detailed configuration of the imaging module 100 according to the present embodiment has been described above. Next, the imaging method according to the present embodiment will be described with reference to FIGS. 9 and 10. As illustrated in FIG. 9, the imaging method according to the present embodiment includes a plurality of steps including steps S201 to S217. Hereinafter, details of each step included in the imaging method according to the present embodiment will be described.

First, in the present embodiment, the above-described light emitting element 112d starts light irradiation.

(Steps S201 to S205)

Since Steps S201 to S205 according to the present embodiment are similar to steps S101, S103, and S107 according to the first embodiment illustrated in FIG. 4, description thereof is omitted here.

(Step S207)

The control unit 150 determines whether or not the imaging unit 130 receives reflected light of all wavelengths. In the present embodiment, when the reflected light of all the wavelengths is received, the process proceeds to a next step S209, and when the reflected light of all the wavelengths is not received, the process returns to the previous step S205.

In the present embodiment, as illustrated in the upper part of FIG. 10, the moving subject 800 is irradiated with white light, for example. Then, as illustrated in the middle part of FIG. 10, in synchronization with timing at which the subject 800 reaches above each of the filters 162a to 162c, the reception of the reflected light from the subject 800 by the imaging element 134, the transfer of the imaging signal to the memory unit 136, and the temporary holding of the imaging signal by the memory unit 136 are sequentially executed. Next, similarly to the first embodiment, as illustrated in the lower part of FIG. 10, in subsequent steps, by collectively reading the imaging signals from the respective memory units 136, a one frame image including imaging 802 of the subject 800 corresponding to each wavelength can be acquired.

(Steps S209 to S217)

Since steps S209 to S217 according to the present embodiment are similar to steps S113 to S121 according to the first embodiment illustrated in FIG. 4, respectively, description thereof is omitted here.

### 4. Third Embodiment

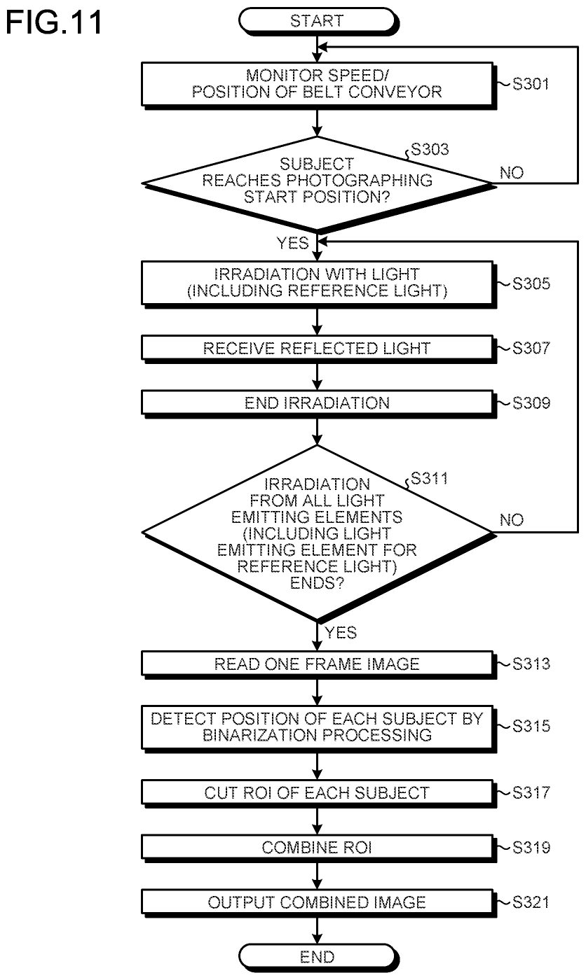

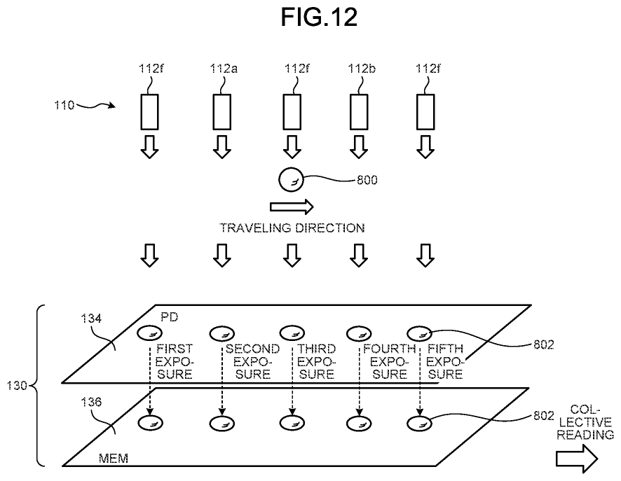

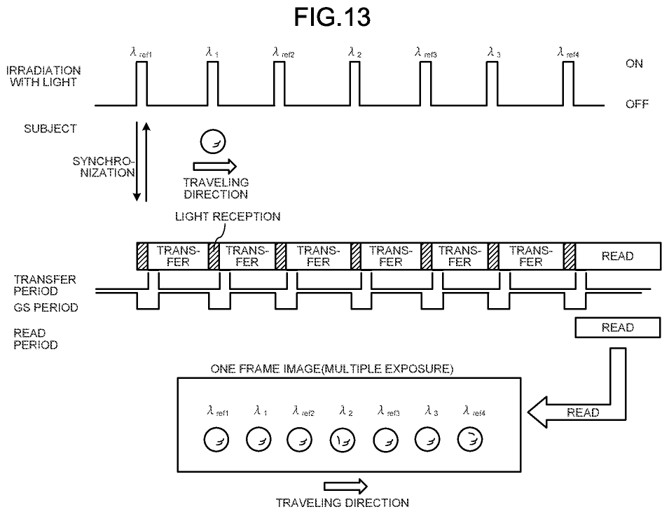

In the first embodiment described above, a one frame image including imaging 802 of a subject 800 corresponding to reflected light of each wavelength (for example, wavelengths λ1 to λ₇) is converted into a two-step color tone image, and a position of the imaging 802 of each subject 800 in the one frame image is specified. On the other hand, in a third embodiment of the present disclosure described below, in order to further improve the accuracy of the position detection, the position of the imaging 802 of the subject 800 corresponding to the reflected light of each wavelength other than visible light may be specified using a one frame image including the imaging 802 of the subject 800 corresponding to the reflected light of the visible light (reference light). In this way, in the present embodiment, since a visible light image or the like in which the contour of the imaging 802 is easily detected in the two-step color tone image can be used, the position of the imaging 802 of the subject 800 corresponding to reflected light of near infrared light or the like other than the visible light can be accurately detected. Therefore, the third embodiment will be described with reference to FIGS. 11 to 14. FIG. 11 is a flowchart for explaining an example of the imaging method according to the present embodiment, and FIGS. 12 to 14 are explanatory diagrams for explaining an example of the imaging method according to the present embodiment.

<4.1 Detailed Configuration of Imaging Module>

First, a detailed configuration of an imaging module 100 according to the present embodiment will be described. In the following description, descriptions of points common to those of the above-described first embodiment will be omitted, and only different points will be described. In the present embodiment, as compared with the first embodiment, an irradiation unit 110 further has a light emitting element (reference light emitting element) 112f (see FIG. 12) capable of irradiating the subject 800 with visible light (reference light). Specifically, in the present embodiment, for example, the light emitting element 112f capable of emitting the visible light is provided between a plurality of light emitting elements 112a and 112b that emit, for example, near infrared light having different wavelengths (for example, wavelengths λ₁ to λ₇). Note that, although a plurality of light emitting elements 112f are illustrated in FIG. 12, the present embodiment is not limited to the plurality of light emitting elements 112f, and one light emitting element 112f may be used. In the present embodiment, for example, irradiation of near infrared light having different wavelengths by the light emitting elements 112a and 112b and irradiation of visible light by the light emitting element 112f are alternately performed. Further, in the following description, the light emitting element 112f is described as emitting the visible light (for example, it has a wavelength λ_{ref}) as the reference light. However, the present embodiment is not limited to the visible light, and for example, light having a predetermined wavelength other than near infrared light may be emitted.

Even in the present embodiment, for example, with the arrival of the subject 800 at the imaging position by a belt conveyor 300 as a trigger, irradiation by the irradiation unit 110 including the light emitting element 112f and an imaging of a global shutter system (multiple exposure) by the imaging unit 130 are performed in synchronization with each other.

<4.2 Imaging Method>

The detailed configuration of the imaging module 100 according to the present embodiment has been described above. Next, an imaging method according to the present embodiment will be described with reference to FIGS. 11 to 14. As illustrated in FIG. 11, the imaging method according to the present embodiment includes a plurality of steps including steps S301 to S321. Hereinafter, details of each step included in the imaging method according to the present embodiment will be described. In the present embodiment, it is assumed that the subject 800 moves at a constant speed by the belt conveyor 300.

(Steps S301 and S303)

Since steps S301 and S303 according to the present embodiment are similar to steps S101 and S103 according to the first embodiment illustrated in FIG. 4, respectively, description thereof is omitted here.

(Step S305)

The control unit 150 controls the light emitting element 112 corresponding to the position of the subject 800 and alternately irradiates the subject 800 with light having visible light (for example, the wavelength λ_{ref}) and near infrared light having a predetermined wavelength (for example, the wavelengths λ₁ to λ₇). Specifically, as illustrated in FIG. 12, each of the light emitting elements 112a, 112b, and 112f irradiates the subject 800 with the visible light or the near infrared light when the subject 800 reaches below the light emitting element.

(Step S307)

The control unit 150 controls the plurality of imaging elements 134 such that the plurality of imaging elements 134 receive the reflected light from the subject 800, in synchronization with the irradiation of the light emitting element 112 in step S305. For example, as illustrated in FIG. 12, the plurality of imaging elements 134 perform light reception in synchronization with the irradiation of the light emitting elements 112a, 112b, and 112f, generate imaging 802 of the a subject obtained by the light reception as an imaging signal, and output the generated imaging signal to each memory unit 136. Furthermore, each memory unit 136 temporarily holds the imaging signal. Note that the imaging signal corresponds to the imaging 802 of the subject 800 corresponding to each wavelength (for example, the wavelengths λ₁ to λ₇ and λ_{ref}) of the light emitted by the light emitting elements 112a, 112b, and 112f in step S305, and each imaging 802 is included in a one frame image to be described later.

(Steps S309 to S313)

Since steps S309 to S313 according to the present embodiment are similar to steps S109 to S113 according to the first embodiment illustrated in FIG. 4, respectively, description thereof is omitted here.

(Step S315)

The control unit 150 controls the binarization processing unit 142 of the combining unit 140 and performs binarization processing of converting the one frame image acquired in step S313 into a two-step color tone to generate a two-step color tone image (for example, a black-and-white image is generated).

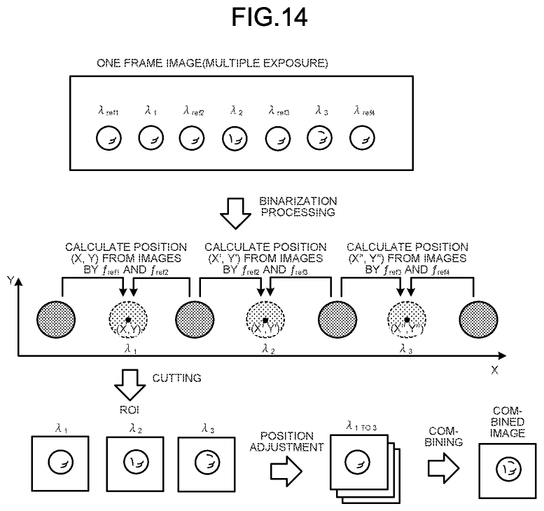

Furthermore, as illustrated in the middle part of FIG. 14, the control unit 150 controls an imaging region specifying unit 144 of the combining unit 140 and detects the contour of each imaging 802 of the subject 800 corresponding to visible light included in the image after the binarization processing. Next, the control unit 150 controls the imaging region specifying unit 144 of the combining unit 140 and detects the center coordinates (X, Y) of the imaging 802 of the subject 800 corresponding to the near infrared light sandwiched between the two imaging 802 from the positions of the respective imaging 802 of the subject 800 corresponding to the visible light. In the present embodiment, since the subject 800 moves at a constant speed by the belt conveyor 300, the imaging 802 of the subject 800 corresponding to the near infrared light is located at the center between the two imaging 802 of the subject 800 corresponding to the visible light in a one frame image. Therefore, in the present embodiment, the center coordinates (X, Y) of the imaging 802 of the subject 800 corresponding to the near infrared light or the like can be accurately detected by calculating the center of the two imaging 802 using the two imaging 802 corresponding to the visible light in which it is easy to detect the contour in the two-step color tone image.

(Steps S317 to S321)

Since steps S317 to S321 according to the present embodiment are similar to steps S117 to S121 according to the first embodiment illustrated in FIG. 4, respectively, description thereof is omitted here.

As described above, in the present embodiment, the position of the imaging 802 of the subject 800 corresponding to the near infrared light or the like can be accurately detected by calculating the center of the two imaging 802 using the two imaging 802 corresponding to the visible light in which it is easy to detect the contour in the two-step color tone image.

### 5. Fourth Embodiment

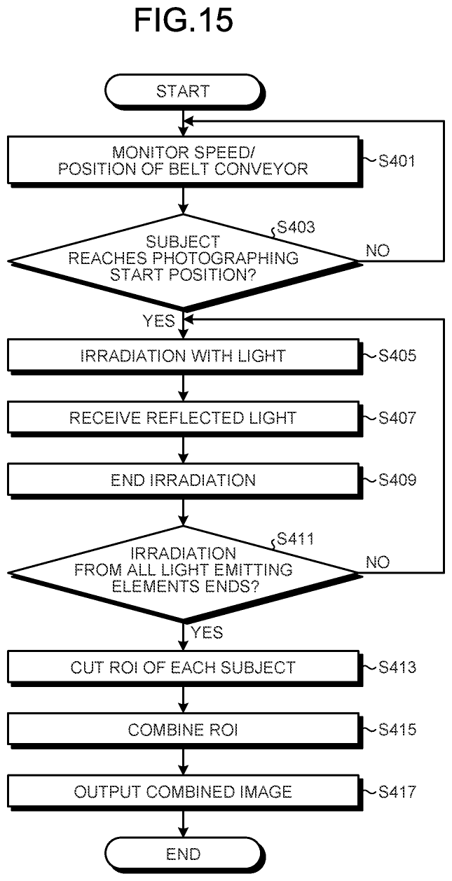

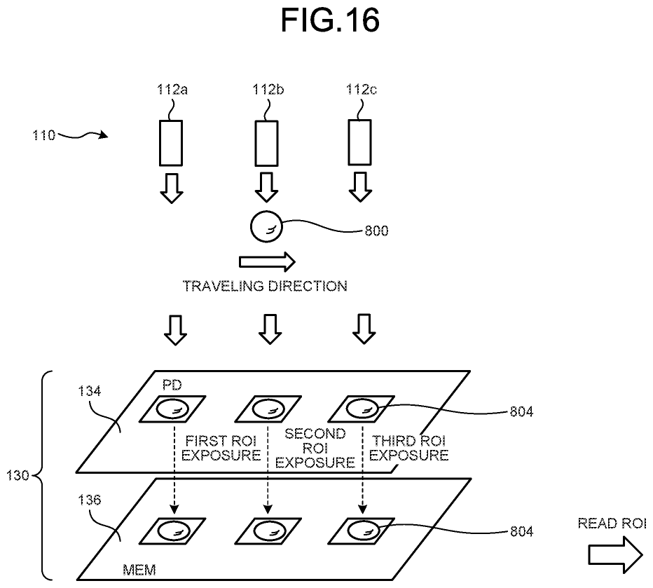

In the first embodiment described above, a position of imaging 802 of a subject 800 corresponding to near infrared light or the like is detected using a two-step color tone image. On the other hand, in an embodiment described below, when the position of the imaging 802 of the subject 800 in the one frame image is known in advance, only an imaging signal from a corresponding pixel (imaging element 134) in each ROI may be acquired from the beginning on the basis of a plurality of predetermined regions designated in advance by a user in the one frame image. In this way, in the present embodiment, it is possible to reduce an amount of imaging signals to be collectively read by a reading unit 138 and to reduce the burden of subsequent processing. Therefore, a fourth embodiment of the present disclosure will be described with reference to FIGS. 15 and 16. FIG. 15 is a flowchart for explaining an example of an imaging method according to the present embodiment, and FIG. 16 is an explanatory diagram for explaining an example of the imaging method according to the present embodiment.

<5.1 Detailed Configuration of Imaging Module>

A detailed configuration of an imaging module 100 according to the present embodiment is common to the first embodiment described above, except that a combining unit 140 is not provided with a binarization processing unit 142 and an imaging region specifying unit 144. Therefore, description thereof is omitted here.

<5.2 Imaging Method>

Next, the imaging method according to the present embodiment will be described with reference to FIGS. 15 and 16. As illustrated in FIG. 15, the imaging method according to the present embodiment includes a plurality of steps including steps S401 to S417. Hereinafter, details of each step included in the imaging method according to the present embodiment will be described. In the present embodiment, it is assumed that the position of the imaging 802 of the subject 800 in the one frame image is known in advance.

(Steps S401 to S405)

Since steps S401 to S405 according to the present embodiment are similar to steps S101 to S105 according to the first embodiment illustrated in FIG. 4, respectively, description thereof is omitted here.

(Step S407)

Similarly to the first embodiment, a control unit 150 controls a plurality of imaging elements 134 such that the plurality of imaging elements 134 receive the reflected light from the subject 800, in synchronization with the irradiation of a light emitting element 112 in step S405. In the present embodiment, as illustrated in FIG. 16, the corresponding imaging element 134 in each of ROIs 804 corresponding to the plurality of predetermined regions designated in advance by the user receives light in synchronization with the irradiation of each of the light emitting elements 112a to 112c, generates the imaging 802 of the subject obtained by the light reception as an imaging signal (a part of signal information), and outputs the generated imaging signal to each memory unit 136. Furthermore, each memory unit 136 temporarily holds the imaging signal. Note that the imaging signal corresponds to an ROI 804 of each wavelength (for example, wavelengths λ₁ to λ₇) of the light emitted by the light emitting element 112 in step S405, and each ROI 804 is included in a one frame image to be described later (that is, ROI exposure). That is, in the present embodiment, since only the corresponding imaging signal in each of the ROIs 804 corresponding to the plurality of predetermined regions designated in advance by the user is read, the amount of imaging signals read collectively by the reading unit 138 can be reduced, and the burden of subsequent processing can be reduced.

(Steps S409 and S411)

Since steps S409 and S411 according to the present embodiment are similar to steps S109 and S111 according to the first embodiment illustrated in FIG. 4, respectively, description thereof is omitted here.

(Step S413)

The control unit 150 controls the combining processing unit 146 of the combining unit 140 and cuts each ROI included in the one frame image.

(Steps S415 and S417)

Since steps S415 and S417 according to the present embodiment are similar to steps S119 and S121 according to the first embodiment illustrated in FIG. 4, respectively, description thereof is omitted here.

As described above, in the present embodiment, when the position of the imaging 802 of the subject 800 in the one frame image is known in advance, only the imaging signal from the corresponding pixel in each ROI 804 is acquired from the beginning on the basis of the plurality of predetermined regions designated in advance by the user in the one frame image. In this way, according to the present embodiment, it is possible to reduce the amount of imaging signals to be collectively read by the reading unit 138 and to reduce the burden of subsequent processing.

### 6. Fifth Embodiment

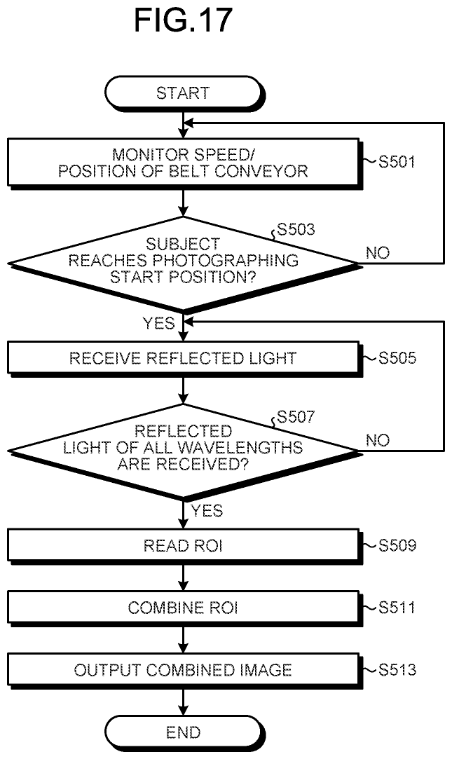

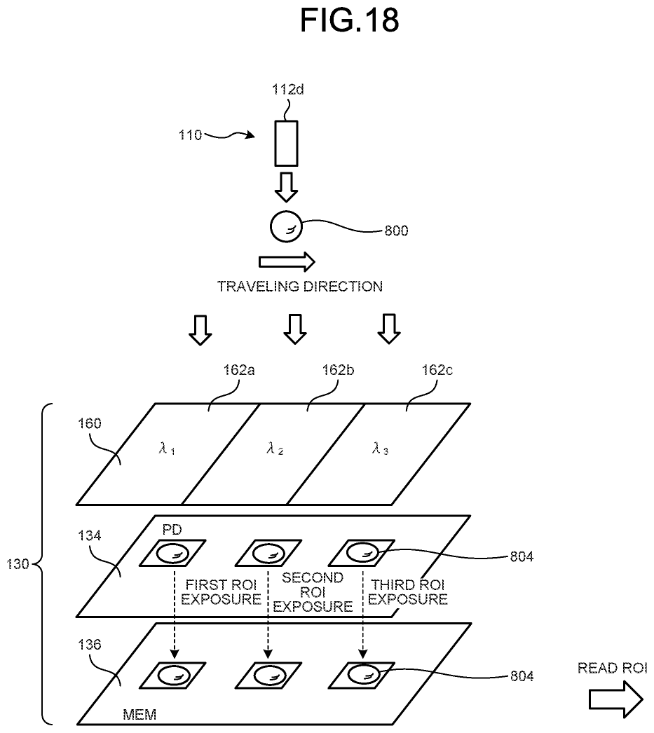

In the present disclosure, an imaging method according to the fourth embodiment described above can also be applied to an imaging module 100 according to the second embodiment. In this way, according to an embodiment described below, an amount of imaging signals collectively read by a reading unit 138 can be reduced, and the burden of subsequent processing can be reduced. In addition, an irradiation unit 110 having a special configuration is unnecessary, and a general lighting device or the like can be used. Therefore, a fifth embodiment of the present disclosure will be described with reference to FIGS. 17 and 18. FIG. 17 is a flowchart for explaining an example of an imaging method according to the present embodiment, and FIG. 18 is an explanatory diagram for explaining an example of the imaging method according to the present embodiment.

<6.1 Detailed Configuration of Imaging Module>

A detailed configuration of an imaging module 100 according to the present embodiment is common to the second embodiment described above, except that a combining unit 140 is not provided with a binarization processing unit 142 and an imaging region specifying unit 144. Therefore, description thereof is omitted here.

<6.2 Imaging Method>

Next, the imaging method according to the present embodiment will be described with reference to FIGS. 17 and 18. As illustrated in FIG. 17, the imaging method according to the present embodiment includes a plurality of steps including steps S501 to S513. Hereinafter, details of each step included in the imaging method according to the present embodiment will be described. Even in the present embodiment, it is assumed that a position of imaging 802 of a subject 800 in a one frame image is known in advance.

(Steps S501 and S503)

Since steps S501 and S503 according to the present embodiment are similar to steps S101 and S103 according to the first embodiment illustrated in FIG. 4, respectively, description thereof is omitted here.

(Step S505)

A control unit 150 controls a plurality of imaging elements 134 such that the plurality of imaging elements 134 receive reflected light from a subject 800. In the present embodiment, similarly to the above-described fourth embodiment, as illustrated in FIG. 18, the corresponding imaging element 134 in each of ROIs 804 corresponding to a plurality of predetermined regions designated in advance by a user performs light reception, generates imaging 802 of the subject obtained by the light reception as an imaging signal (a part of signal information), and outputs the generated imaging signal to each memory unit 136. Furthermore, each memory unit 136 temporarily holds the imaging signal. Note that the imaging signal corresponds to the ROI 804 of each wavelength (for example, wavelengths λ₁ to λ₇) of the light transmitted by each of filters 162a to 162c, and each ROI 804 is included in a one frame image to be described later (that is, ROI exposure). That is, in the present embodiment, since only the corresponding imaging signal in each of the ROIs 804 corresponding to the plurality of predetermined regions designated in advance by the user is read, the amount of imaging signals read collectively by the reading unit 138 can be reduced, and the burden of subsequent processing can be reduced.

(Step S507)

Since step S507 according to the present embodiment is similar to step S207 according to the second embodiment illustrated in FIG. 9, description thereof is omitted here.

(Step S509)

Since step S509 according to the present embodiment is similar to step S413 according to the fourth embodiment illustrated in FIG. 15 except that each ROI is read, description thereof is omitted here.

(Steps S511 and S513)

Since steps S511 and S513 according to the present embodiment are similar to steps S119 and S121 according to the first embodiment illustrated in FIG. 4, respectively, description thereof is omitted here.

As described above, according to the present embodiment, the amount of imaging signals collectively read by the reading unit 138 can be reduced, and the burden of subsequent processing can be reduced. In addition, the irradiation unit 110 having the special configuration is unnecessary, and a general lighting device or the like can be used.

### 7. Sixth Embodiment

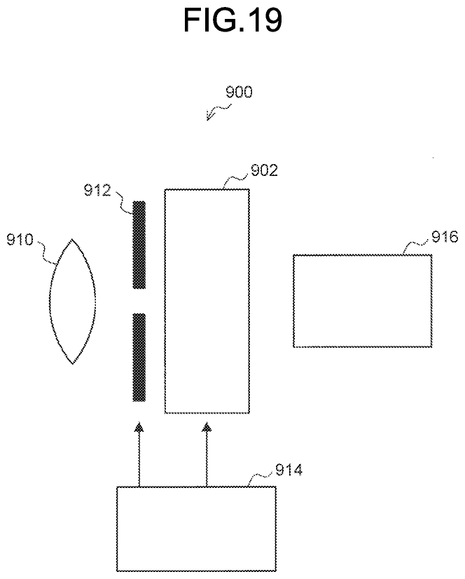

The technology according to the embodiment of the present disclosure described above is applicable to all electronic apparatuses using an imaging apparatus in an image capturing unit, such as an imaging apparatus such as a digital still camera or a video camera, a mobile terminal device having an imaging function, and a copying machine using an imaging apparatus in an image reading unit. Furthermore, the technology of the present disclosure is also applicable to automobiles, robots, aircraft, drones, various inspection apparatuses (for example, food inspection or the like), medical devices (endoscopes), and the like. Hereinafter, an example of an electronic apparatus 900 to which the technology according to the embodiment of the present disclosure is applied will be described as a sixth embodiment of the present disclosure with reference to FIG. 19. FIG. 19 is an explanatory diagram illustrating an example of the electronic apparatus 900 according to the present embodiment.

As illustrated in FIG. 19, the electronic apparatus 900 has an imaging apparatus 902, an optical lens (corresponding to a lens unit 132 in FIG. 2) 910, a shutter mechanism 912, a drive circuit unit (corresponding to a control unit 150 in FIG. 2) 914, and a signal processing circuit unit (corresponding to a combining unit 140 in FIG. 2) 916. The optical lens 910 forms an image of image light (incident light) from a subject on a plurality of imaging elements 134 (see FIG. 2) on a light receiving surface of the imaging apparatus 902. As a result, signal charges are accumulated in a memory unit 136 (see FIG. 2) of the imaging apparatus 902 during a certain period. The shutter mechanism 912 performs opening/closing operation to control a light emission period and a light shielding period to the imaging apparatus 902. The drive circuit unit 914 supplies drive signals for controlling signal transfer operation of the imaging apparatus 902, shutter operation of the shutter mechanism 912, or the like to them. That is, the imaging apparatus 902 performs signal transfer on the basis of the drive signal (timing signal) supplied from the drive circuit unit 914. The signal processing circuit unit 916 can perform various types of signal processing.

Note that the embodiment of the present disclosure is not limited to being applied to an inspection device that inspects, in a manufacturing line installed at a manufacturing site or the like, the presence or absence of scratches, the presence or absence of mixing of a foreign material, and whether or not an appearance of a manufactured product is an acceptable product suitable for shipment, on the basis of an image of the appearance of the product. For example, the present embodiment can be applied to appearance inspection of an industrial product (presence or absence of scratches and determination of shipment conformity of appearance of a manufactured product) and the like. In addition, since the present embodiment can use light of various wavelengths, the present embodiment can also be used, for example, for foreign material mixing inspection of pharmaceuticals and foods or the like, on the basis of light absorption characteristics specific to substances (light absorption characteristics specific to a foreign material can be used). Furthermore, in the present embodiment, since light of various wavelengths can be used, for example, color recognition, a depth at which a scratch or a foreign material is located, and the like, which are rarely recognized with visible light, can be detected.

### 8. Application to Mobile Object

Further, in the embodiment of the present disclosure, instead of moving the subject 800, an imaging module 100 may be mounted on a mobile object to cause the imaging module 100 side to move. For example, when the imaging module 100 is mounted on a mobile object such as a drone, light of a predetermined wavelength may be emitted in a case where the subject 800 is positioned directly below a light emitting element 112 of the imaging module 100. In this case, according to the present embodiment, it is possible to detect a distribution of a specific component on a ground surface or the like and detect a state of a crop. That is, the imaging module 100 according to the present embodiment may be realized as a device mounted on any kind of mobile object, such as an automobile, an electric vehicle, a hybrid electric vehicle, a motorcycle, a bicycle, a personal mobility, an airplane, a drone, a ship, or a robot.

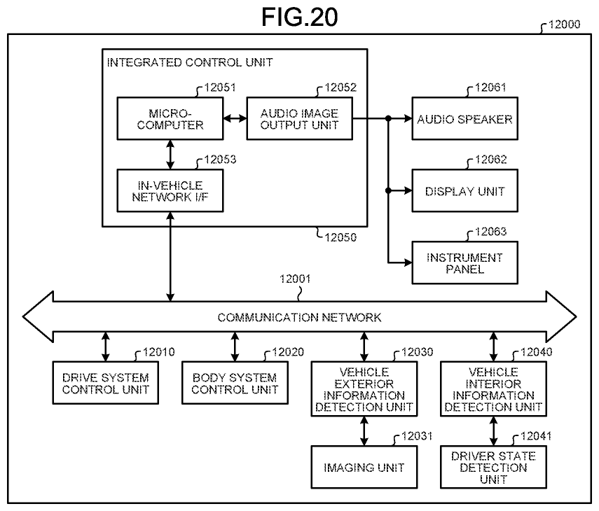

FIG. 20 is a block diagram illustrating a schematic configuration example of a vehicle control system that is an example of a mobile object control system to which the technology according to the present disclosure can be applied.

A vehicle control system 12000 includes a plurality of electronic control units connected via a communication network 12001. In the example illustrated in FIG. 20, the vehicle control system 12000 includes a drive system control unit 12010, a body system control unit 12020, a vehicle exterior information detection unit 12030, a vehicle interior information detection unit 12040, and an integrated control unit 12050. In addition, as a functional configuration of the integrated control unit 12050, a microcomputer 12051, an audio image output unit 12052, and an in-vehicle network interface (I/F) 12053 are illustrated.

The drive system control unit 12010 controls the operation of the devices related to the drive system of the vehicle according to various programs. For example, the drive system control unit 12010 functions as a driving force generation device for generating a driving force of a vehicle such as an internal combustion engine or a driving motor, a driving force transmission mechanism for transmitting the driving force to wheels, a steering mechanism for regulating the steering angle of the vehicle, and a control device such as a braking device for generating a braking force of the vehicle.

The body system control unit 12020 controls the operation of various devices mounted on the vehicle body according to various programs. For example, the body system control unit 12020 functions as a keyless entry system, a smart key system, a power window device, or a control device for various lamps such as headlamps, rear lamps, brake lamps, blinkers, or fog lamps. In this case, the body system control unit 12020 can receive radio waves transmitted from a portable device that substitutes for a key, or signals from various switches. The body system control unit 12020 receives input of these radio waves or signals, and controls a door lock device, a power window device, lamps, and the like of the vehicle.

The vehicle exterior information detection unit 12030 detects information outside the vehicle on which the vehicle control system 12000 is mounted. For example, an imaging unit 12031 is connected to the vehicle exterior information detection unit 12030. The vehicle exterior information detection unit 12030 causes the imaging unit 12031 to capture an image outside the vehicle and receives the captured image. The vehicle exterior information detection unit 12030 may perform object detection processing of a person, a car, an obstacle, a sign, or characters on a road surface, or distance detection processing, on the basis of the received image.

The imaging unit 12031 is an optical sensor that receives light and outputs an electric signal corresponding to the amount of received light. The imaging unit 12031 can output an electric signal as an image or as distance measurement information. In addition, the light received by the imaging unit 12031 may be visible light or invisible light such as infrared rays.

The vehicle interior information detection unit 12040 detects vehicle interior information. For example, a driver state detection unit 12041 that detects the state of the driver is connected to the vehicle interior information detection unit 12040. The driver state detection unit 12041 includes, for example, a camera that captures the driver, and the vehicle interior information detection unit 12040 may calculate, in accordance with the detected information input from the driver state detection unit 12041, the degree of tiredness or concentration of the driver or determine whether or not the driver is asleep.

A microcomputer 12051 is able to calculate a control target value of the driving force generation device, the steering mechanism, or the braking device, on the basis of the information inside and outside the vehicle acquired by the vehicle exterior information detection unit 12030 or the vehicle interior information detection unit 12040, to output a control command to the drive system control unit 12010. For example, the microcomputer 12051 can perform cooperative control for the purpose of implementing advanced driver assistance system (ADAS) functions including vehicle collision avoidance or impact mitigation, tracking based on inter-vehicle distance, vehicle speed maintenance, vehicle collision warning, or vehicle lane departure warning.

In addition, the microcomputer 12051 can also perform cooperative control for the purpose of automatic driving to travel the vehicle autonomously without relying on the operation of the driver by controlling the driving force generation device, the steering mechanism, or the braking device in accordance with the information around the vehicle acquired by the vehicle exterior information detection unit 12030 or the vehicle interior information detection unit 12040.

Further, the microcomputer 12051 can output a control command to the body system control unit 12020 on the basis of the information outside the vehicle acquired by the vehicle exterior information detection unit 12030. For example, the microcomputer 12051 can control the headlamps according to the position of the preceding vehicle or oncoming vehicle detected by the vehicle exterior information detection unit 12030, and can perform cooperative control for the purpose of anti-glare, such as switching a high beam to a low beam.

The audio image output unit 12052 transmits an output signal of at least one of audio and image to an output device capable of visually or audibly providing information to a vehicle occupant or the outside of the vehicle. In the example of FIG. 20, an audio speaker 12061, a display unit 12062, and an instrument panel 12063 are illustrated as output devices. The display unit 12062 may include at least one of an on-board display and a head-up display, for example.

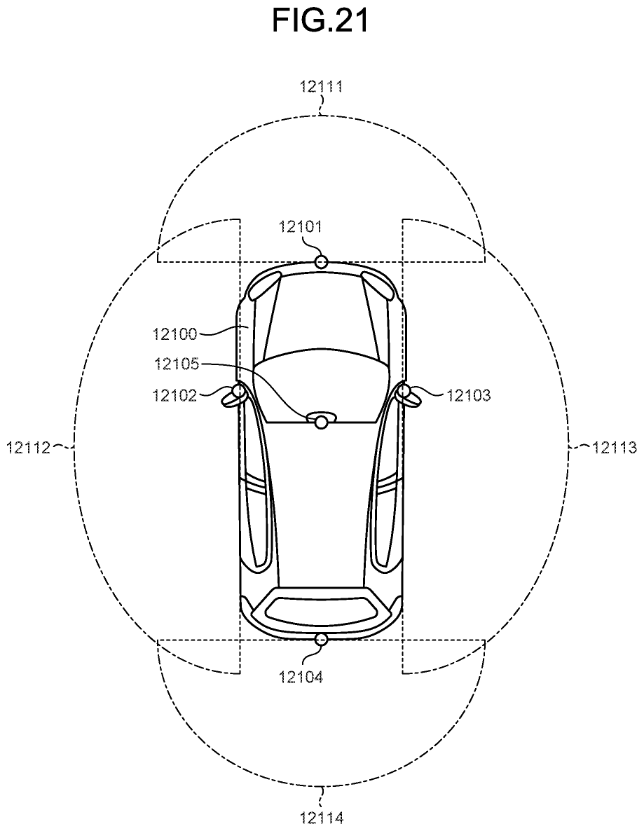

FIG. 21 is a diagram illustrating an example of an installation position of the imaging unit 12031.

In FIG. 21, a vehicle 12100 has imaging units 12101, 12102, 12103, 12104, and 12105 as the imaging unit 12031.

The imaging units 12101, 12102, 12103, 12104, and 12105 are provided, for example, at positions including a front nose, a side mirror, a rear bumper, a rear door, and an upper portion of a windshield in the vehicle interior of the vehicle 12100. The imaging unit 12101 provided at the front nose and the imaging unit 12105 provided at the upper portion of the windshield in the vehicle interior mainly acquire an image in front of the vehicle 12100. The imaging units 12102 and 12103 provided at the side mirrors mainly acquire images of the side of the vehicle 12100. The imaging unit 12104 provided at the rear bumper or the rear door mainly acquires an image behind the vehicle 12100. The front images acquired by the imaging units 12101 and 12105 are mainly used for detecting a preceding vehicle, a pedestrian, an obstacle, a traffic signal, a traffic sign, a lane, or the like.

Note that FIG. 21 illustrates an example of the imaging range of the imaging units 12101 to 12104. An imaging range 12111 indicates the imaging range of the imaging unit 12101 provided at the front nose, imaging ranges 12112 and 12113 indicate the imaging ranges of the imaging units 12102 and 12103 provided at the side mirrors, and an imaging range 12114 indicates the imaging range of the imaging unit 12104 provided at the rear bumper or the rear door. For example, by superimposing the image data captured by the imaging units 12101 to 12104, an overhead image when the vehicle 12100 is viewed from above is obtained.

At least one of the imaging units 12101 to 12104 may have a function of acquiring distance information. For example, at least one of the imaging units 12101 to 12104 may be a stereo camera including a plurality of imaging elements, or may be an imaging element having pixels for phase difference detection.

For example, the microcomputer 12051 uses the distance information obtained from the imaging units 12101 to 12104 to calculate the distance to a three-dimensional object in the imaging ranges 12111 to 12114 and the temporal change of the distance (relative speed with respect to the vehicle 12100), so that it is possible to extract, particularly as a preceding vehicle, the closest three-dimensional object on the traveling path of the vehicle 12100 and the three-dimensional object that travels at a predetermined speed (e.g., 0 km/h or more) in substantially the same direction as the vehicle 12100. Further, the microcomputer 12051 can set an inter-vehicle distance to be secured in advance before the preceding vehicle, and can perform automatic brake control (including follow-up stop control), automatic acceleration control (including follow-up start control), and the like. In this way, it is possible to perform the cooperative control for the purpose of automatic driving or the like to travel autonomously without relying on the operation of the driver.

For example, the microcomputer 12051 can classify three-dimensional object data related to the three-dimensional object, on the basis of the distance information obtained from the imaging units 12101 to 12104, extracts other three-dimensional objects such as two-wheeled vehicles, ordinary vehicles, large vehicles, pedestrians, and power poles, and uses the extracted data for automatic avoidance of obstacles. For example, the microcomputer 12051 distinguishes obstacles around the vehicle 12100 between obstacles visible to the driver of the vehicle 12100 and obstacles difficult to recognize visually. In addition, the microcomputer 12051 determines the collision risk indicating the risk of collision with each obstacle and, if the collision risk is a setting value or more and indicates the possibility of collision, the microcomputer 12051 can assist driving to avoid collision by outputting an alarm to the driver via the audio speaker 12061 or the display unit 12062, or executing forced deceleration or avoidance steering via the drive system control unit 12010.

At least one of the imaging units 12101 to 12104 may be an infrared camera that detects infrared rays. For example, the microcomputer 12051 can recognize a pedestrian by determining whether or not a pedestrian is present in the captured images of the imaging units 12101 to 12104. Such pedestrian recognition is carried out, for example, by determining whether or not a person is a pedestrian by performing pattern matching processing on a sequence of feature points indicating a contour of the object and a procedure for extracting feature points in the captured images of the imaging units 12101 to 12104 as infrared cameras. When the microcomputer 12051 determines that the pedestrian exists in the captured images of the imaging units 12101 to 12104 and recognizes the pedestrian, the audio image output unit 12052 controls the display unit 12062 to display a rectangular contour line for emphasizing the recognized pedestrian in a superimposed manner. Further, the audio image output unit 12052 may control the display unit 12062 so as to display an icon or the like indicating a pedestrian at a desired position.

The example of the vehicle control system to which the technology according to the present disclosure can be applied has been described above. The technology according to the present disclosure is applicable to the imaging unit 12031 and the like among the configurations described above.

### 9. Summary

As described above, according to each embodiment of the present disclosure, it is possible to avoid a complicated configuration and an increase in manufacturing cost of the imaging module 100, without requiring a large number of optical components such as a diffraction grating and a mirror. Furthermore, according to each embodiment of the present disclosure, since a combined image is generated using a one frame image, it is possible to generate an image obtained by combining a plurality of spectral images into one image in an imaging time for one frame. That is, according to the present embodiment, it is possible to obtain a combined image of spectral images with a simple configuration and at high speed.

Note that, in the embodiments and the modifications of the present disclosure described above, it has been described that a combined image is generated by superimposing a plurality of cut ROIs. However, each of the embodiments and modifications of the present disclosure is not limited thereto. For example, in each embodiment, the one frame image may be output, or the ROI cut from the one frame image may be output. For example, in this case, since images corresponding to respective wavelengths of light can be separately acquired and analyzed, it is possible to easily recognize the presence or absence, distribution, and the like of components for the corresponding wavelengths.

### 10. Supplement

Note that the embodiment of the present disclosure described above can include, for example, a program for causing a computer to function as the imaging system 10 according to the present embodiment, and a non-transitory tangible medium on which the program is recorded. In addition, the program may be distributed via a communication line (including wireless communication) such as the Internet.

Further, each step in the imaging method according to the embodiment of the present disclosure described above may not necessarily be processed in the described order. For example, each step may be processed in appropriately changed order. In addition, each step may be partially processed in parallel or individually instead of being processed in time series. Furthermore, the processing method of each step may not necessarily be processed according to the described method, and may be processed by another method by another functional unit, for example.

The preferred embodiments of the present disclosure have been described in detail with reference to the accompanying drawings, but the technical scope of the present disclosure is not limited to such examples. It is obvious that a person with an ordinary skill in a technological field of the present disclosure could conceive of various alterations or corrections within the scope of the technical ideas described in the appended claims, and it should be understood that such alterations or corrections will naturally belong to the technical scope of the present disclosure.

Furthermore, the effects described in the present specification are merely illustrative or exemplary and are not restrictive. That is, the technology according to the present disclosure can exhibit other effects obvious to those skilled in the art from the description of the present specification in addition to or in place of the above effects.

Note that the present technology can also take the following configurations.

(1) An imaging device comprising:

an imaging unit that generates a one frame image by sequentially receiving each reflected light reflected by a subject by intermittently and sequentially irradiating the subject with each irradiation light having a different wavelength according to a position of the moving subject, temporarily and sequentially holding signal information based on the reflected light of each wavelength, and collectively reading the held signal information; and

a combining unit that generates a combined image by cutting a subject image corresponding to the reflected light of each wavelength from the one frame image and superimposing a plurality of the cut subject images.

(2) The imaging device according to (1), wherein

the imaging unit has a plurality of pixels, and

each of the pixels includes

an imaging element that receives the reflected light to generate the signal information, and

a memory unit that temporarily holds the signal information from the imaging element.

(3) The imaging device according to (2), wherein

the imaging unit operates in a global shutter system that collectively reads the signal information held in the each memory unit.

(4) The imaging device according to (2) or (3), wherein

the pixel includes an InGaAs imaging element that detects near infrared light.

(5) The imaging device according to any one of (2) to (4), wherein

the combining unit cuts each subject image corresponding to the reflected light of each wavelength by cutting a plurality of predetermined regions designated in advance from the one frame image.

(6) The imaging device according to any one of (2) to (4), wherein

the combining unit has an imaging region specifying unit that specifies each subject image corresponding to the reflected light of each wavelength in the one frame image.

(7) The imaging device according to (6), wherein

the combining unit further has a binarization processing unit that converts the one frame image into a two-step color tone to generate a two-step color tone image, and

the imaging region specifying unit specifies each subject image corresponding to the reflected light of each wavelength, on the basis of the two-step color tone image.

(8) The imaging device according to (6), wherein

the imaging unit sequentially receives each reference light reflected by the subject by intermittently and sequentially irradiating, with the each irradiation light, the subject moving at a constant speed along a predetermined direction before and after irradiation with the each irradiation light,

the imaging unit generates the one frame image including a subject image corresponding to the reference light by temporarily and sequentially holding the signal information based on the reference light and collectively reading the held signal information, and

the imaging region specifying unit specifies a subject image corresponding to the reflected light of each wavelength located between subject images corresponding to the two reference lights, on the basis of the subject images corresponding to the two reference lights.

(9) The imaging device according to any one of (2) to (8), wherein

the combining unit has a combining processing unit that calculates a color parameter of each of the pixels in the subject image corresponding to the reflected light of each wavelength, on the basis of color information set in advance to correspond to the each wavelength and signal information of each of the pixels in the subject image corresponding to the reflected light of each wavelength, calculates an addition average of the color parameters in the plurality of subject images for each of the pixels, and generates a color image as the combined image on the basis of the calculated addition average.

(10) The imaging device according to any one of (1) to (9), wherein

the imaging unit has a plurality of filters that are provided to face the subject, are sequentially arranged along a moving direction of the subject, and transmit light of different wavelengths.

(11) The imaging device according to (10), wherein

the plurality of filters are an on-chip color filter or a plasmon filter.

(12) The imaging device according to any one of (1) to (9), further comprising:

an irradiation unit that intermittently and sequentially irradiates the subject with the irradiation light having a different wavelength according to a position of the moving subject.

(13) The imaging device according to (12), wherein

the irradiation unit has a plurality of light emitting elements that emit light of different wavelengths.

(14) The imaging device according to (13), wherein

the plurality of light emitting elements include a plurality of light emitting diodes that emit near infrared light.

(15) The imaging device according to (13) or (14), wherein

the plurality of light emitting elements include a reference light emitting element that emits reference light having a predetermined wavelength other than near infrared light.

(16) The imaging device according to (15), wherein

the reference light emitting element emits visible light as the reference light.

(17) The imaging device according to any one of (12) to (16), further comprising:

a control unit that controls the imaging unit such that the imaging unit receives the reflected light in synchronization with irradiation by the irradiation unit.

(18) An imaging device comprising:

an imaging unit that generates a one frame image by sequentially receiving each reflected light reflected by a subject by intermittently and sequentially irradiating the subject with each irradiation light having a different wavelength according to a position of the moving subject, temporarily and sequentially holding signal information based on the reflected light of each wavelength, and collectively reading a part of the signal information corresponding to a plurality of predetermined regions designated in advance in the held signal information; and

a combining unit that generates a combined image by cutting a subject image corresponding to the reflected light of each wavelength from the one frame image and superimposing a plurality of the cut subject images.

(19) An imaging system comprising:

a moving device that moves a subject;

an irradiation device that intermittently and sequentially irradiates the subject with irradiation light having a different wavelength according to a position of the moving subject;

an imaging apparatus that generates a one frame image by sequentially receiving each reflected light reflected by the subject by the irradiation, temporarily and sequentially holding signal information based on the reflected light of each wavelength, and collectively reading the held signal information; and

a combining device that generates a combined image by cutting a subject image corresponding to the reflected light of each wavelength from the one frame image and superimposing a plurality of the cut subject images.

(20) An imaging method comprising:

generating a one frame image by sequentially receiving each reflected light reflected by a subject by intermittently and sequentially irradiating the subject with each irradiation light having a different wavelength according to a position of the moving subject, temporarily and sequentially holding signal information based on the reflected light of each wavelength, and collectively reading the held signal information; and

generating a combined image by cutting a subject image corresponding to the reflected light of each wavelength from the one frame image and superimposing a plurality of the cut subject images.

Reference Signs List

| | |
|---|---|
| 10 | IMAGING SYSTEM |
| 100 | IMAGING MODULE |
| 110 | IRRADIATION UNIT |
| 112a, 112b, 112c, | LIGHT EMITTING ELEMENT |
| 112d, 112f | |
| 120 | IMAGING DEVICE |
| 130 | IMAGING UNIT |
| 132 | LENS UNIT |
| 134 | IMAGING ELEMENT |
| 136 | MEMORY UNIT |
| 138 | READING UNIT |
| 140 | COMBINING UNIT |
| 142 | BINARIZATION PROCESSING UNIT |
| 144 | IMAGING REGION SPECIFYING UNIT |
| 146 | COMBINING PROCESSING UNIT |
| 150 | CONTROL UNIT |
| 160 | FILTER UNIT |
| 162a, 162b, 162c | FILTER |
| 200 | CONTROL SERVER |
| 300 | BELT CONVEYOR |
| 410 | PIXEL ARRAY UNIT |
| 432 | VERTICAL DRIVE CIRCUIT UNIT |
| 434 | COLUMN SIGNAL PROCESSING CIRCUIT UNIT |
| 436 | HORIZONTAL DRIVE CIRCUIT UNIT |
| 438 | OUTPUT CIRCUIT UNIT |
| 440 | CONTROL CIRCUIT UNIT |
| 442 | PIXEL DRIVE WIRE |
| 444 | VERTICAL SIGNAL LINE |
| 446 | HORIZONTAL SIGNAL LINE |
| 448 | INPUT/OUTPUT TERMINAL |
| 480 | PERIPHERAL CIRCUIT UNIT |
| 500 | SEMICONDUCTOR SUBSTRATE |
| 800 | SUBJECT |
| 802 | IMAGING |
| 804 | ROI |
| 804a, 804b, 804c | PIXEL DATA GROUP |
| 806 | PSEUDO COLOR IMAGE |
| 900 | ELECTRONIC APPARATUS |
| 902 | IMAGING APPARATUS |
| 910 | OPTICAL LENS |
| 912 | SHUTTER MECHANISM |
| 914 | DRIVE CIRCUIT UNIT |
| 916 | SIGNAL PROCESSING CIRCUIT UNIT |

1. An imaging device comprising:
an imaging unit that generates a one frame image by sequentially receiving each reflected light reflected by a subject by intermittently and sequentially irradiating the subject with each irradiation light having a different wavelength according to a position of the moving subject, temporarily and sequentially holding signal information based on the reflected light of each wavelength, and collectively reading the held signal information; and
a combining unit that generates a combined image by cutting a subject image corresponding to the reflected light of each wavelength from the one frame image and superimposing a plurality of the cut subject images.

2. The imaging device according to claim 1, wherein
the imaging unit has a plurality of pixels, and
each of the pixels includes
an imaging element that receives the reflected light to generate the signal information, and
a memory unit that temporarily holds the signal information from the imaging element.

3. The imaging device according to claim 2, wherein
the imaging unit operates in a global shutter system that collectively reads the signal information held in the each memory unit.

4. The imaging device according to claim 2, wherein
the pixel includes an InGaAs imaging element that detects near infrared light.

5. The imaging device according to claim 2, wherein
the combining unit cuts each subject image corresponding to the reflected light of each wavelength by cutting a plurality of predetermined regions designated in advance from the one frame image.

6. The imaging device according to claim 2, wherein
the combining unit has an imaging region specifying unit that specifies each subject image corresponding to the reflected light of each wavelength in the one frame image.

7. The imaging device according to claim 6, wherein
the combining unit further has a binarization processing unit that converts the one frame image into a two-step color tone to generate a two-step color tone image, and
the imaging region specifying unit specifies each subject image corresponding to the reflected light of each wavelength, on the basis of the two-step color tone image.

8. The imaging device according to claim 6, wherein
the imaging unit sequentially receives each reference light reflected by the subject by intermittently and sequentially irradiating, with the each irradiation light, the subject moving at a constant speed along a predetermined direction before and after irradiation with the each irradiation light,
the imaging unit generates the one frame image including a subject image corresponding to the reference light by temporarily and sequentially holding the signal information based on the reference light and collectively reading the held signal information, and
the imaging region specifying unit specifies a subject image corresponding to the reflected light of each wavelength located between subject images corresponding to the two reference lights, on the basis of the subject images corresponding to the two reference lights.

9. The imaging device according to claim 2, wherein
the combining unit has a combining processing unit that calculates a color parameter of each of the pixels in the subject image corresponding to the reflected light of each wavelength, on the basis of color information set in advance to correspond to the each wavelength and signal information of each of the pixels in the subject image corresponding to the reflected light of each wavelength, calculates an addition average of the color parameters in the plurality of subject images for each of the pixels, and generates a color image as the combined image on the basis of the calculated addition average.

10. The imaging device according to claim 1, wherein
the imaging unit has a plurality of filters that are provided to face the subject, are sequentially arranged along a moving direction of the subject, and transmit light of different wavelengths.

11. The imaging device according to claim 10, wherein
the plurality of filters are an on-chip color filter or a plasmon filter.

12. The imaging device according to claim 1, further comprising:
an irradiation unit that intermittently and sequentially irradiates the subject with the irradiation light having a different wavelength according to a position of the moving subject.

13. The imaging device according to claim 12, wherein
the irradiation unit has a plurality of light emitting elements that emit light of different wavelengths.

14. The imaging device according to claim 13, wherein
the plurality of light emitting elements include a plurality of light emitting diodes that emit near infrared light.

15. The imaging device according to claim 13, wherein
the plurality of light emitting elements include a reference light emitting element that emits reference light having a predetermined wavelength other than near infrared light.

16. The imaging device according to claim 15, wherein
the reference light emitting element emits visible light as the reference light.

17. The imaging device according to claim 12, further comprising:
a control unit that controls the imaging unit such that the imaging unit receives the reflected light in synchronization with irradiation by the irradiation unit.

18. An imaging device comprising:
an imaging unit that generates a one frame image by sequentially receiving each reflected light reflected by a subject by intermittently and sequentially irradiating the subject with each irradiation light having a different wavelength according to a position of the moving subject, temporarily and sequentially holding signal information based on the reflected light of each wavelength, and collectively reading a part of the signal information corresponding to a plurality of predetermined regions designated in advance in the held signal information; and
a combining unit that generates a combined image by cutting a subject image corresponding to the reflected light of each wavelength from the one frame image and superimposing a plurality of the cut subject images.

19. An imaging system comprising:
a moving device that moves a subject;
an irradiation device that intermittently and sequentially irradiates the subject with irradiation light having a different wavelength according to a position of the moving subject;
an imaging apparatus that generates a one frame image by sequentially receiving each reflected light reflected by the subject by the irradiation, temporarily and sequentially holding signal information based on the reflected light of each wavelength, and collectively reading the held signal information; and
a combining device that generates a combined image by cutting a subject image corresponding to the reflected light of each wavelength from the one frame image and superimposing a plurality of the cut subject images.

20. An imaging method comprising:
generating a one frame image by sequentially receiving each reflected light reflected by a subject by intermittently and sequentially irradiating the subject with each irradiation light having a different wavelength according to a position of the moving subject, temporarily and sequentially holding signal information based on the reflected light of each wavelength, and collectively reading the held signal information; and
generating a combined image by cutting a subject image corresponding to the reflected light of each wavelength from the one frame image and superimposing a plurality of the cut subject images.
